(19) United States
(12) Patent Application Publication
(10) Pub. No.: US 2025/0022103 A1
(43) Pub. Date: Jan. 16, 2025

(54) Image Compositing with Adjacent Low Parallax Cameras

(71) Applicant: Circle Optics, Inc., Rochester, NY (US)

(72) Inventors: Zakariya Niazi, Rochester, NY (US); Andrew F. Kurtz, Macedon, NY (US); Peter O. Stubler, Rochester, NY (US); John Bowron, Burlington (CA); Mitchell H. Baller, Philadelphia, PA (US); Allen Krisiloff, Rochester, NY (US); Grace Annese, Pittsford, NY (US)

(73) Assignee: Circle Optics, Inc., Rochester, NY (US)

(21) Appl. No.: 18/771,629

(22) Filed: Jul. 12, 2024

Related U.S. Application Data
(60) Provisional application No. 63/513,707, filed on Jul. 14, 2023.
(60) Provisional application No. 63/513,721, filed on Jul. 14, 2023.

(51) Int. Cl. G06T 5/50; G06T 7/20; G06T 7/80

(52) U.S. Cl. CPC G06T 5/50; G06T 7/20; G06T 7/80; G06T 2207/20221

(57) ABSTRACT

A low-parallax multi-camera imaging system may enable combination of images from multiple camera channels into a panoramic image. In some examples, the imaging system may be designed to include small areas of overlap between adjacent camera channels. Panoramic images may be generated by compositing image data from multiple camera channels by using techniques described herein. In some examples, contribution of each camera channel may be weighted based on factors such as distances relative to an overlap region or content within the overlap region.

### CROSS REFERENCE TO RELATED APPLICATION

This disclosure claims benefit of priority of: U.S. Provisional Patent Application Ser. No. 63/513,707, entitled “Image Compositing with Adjacent Low Parallax Cameras,” and U.S. Provisional Patent Application Ser. No. 63/513,721 entitled “Visor Type Camera Array Systems,” both of which were filed on Jul. 14, 2023, and the entirety of each of which is incorporated herein by reference.

### DISCLOSURE

This invention was made with U.S. Government support under grant number 2136737 awarded by the National Science Foundation. The Government has certain rights to this invention.

### TECHNICAL FIELD

The present disclosure relates to panoramic low-parallax multi-camera capture devices having a plurality of adjacent and abutting polygonal cameras and to techniques for processing images generated by the individual cameras of such device. The disclosure also relates to the methods and systems for calibrating, tiling, and blending the individual images and an aggregated panoramic image.

### BACKGROUND

Panoramic cameras have substantial value because of their ability to simultaneously capture wide field of view images. The earliest such example is the fisheye lens, which is an ultra-wide-angle lens that produces strong visual distortion while capturing a wide panoramic or hemispherical image. While the field of view (FOV) of a fisheye lens is usually between 100 and 180 degrees, the approach has been extended to yet larger angles, including into the 220-270° range, as provided by Y. Shimizu in U.S. Pat. No. 3,524,697.

As another alternative, panoramic multi-camera devices, with a plurality of cameras arranged around a sphere or a circumference of a sphere, are becoming increasingly common. However, in most of these systems, including those described in U.S. Pat. Nos. 9,451,162 and 9,911,454, both to A. Van Hoff et al., of Jaunt Inc., the plurality of cameras are sparsely populating the outer surface of the device. In order to capture complete 360-degree panoramic images, including for the gaps or seams between the adjacent individual cameras, the cameras then have widened FOVs that overlap one to another. In some cases, as much as 50% of a camera's FOV or resolution may be used for camera-to-camera overlap, which also creates substantial parallax differences between the captured images. Parallax is the visual perception that the position or direction of an object appears to be different when viewed from different positions. Then in the subsequent image processing, the excess image overlap and parallax differences both complicate and significantly slow the efforts to properly combine, tile or stitch, and synthesize acceptable images from the images captured by adjacent cameras. As discussed in U.S. Pat. No. 11,064,116, by B. Adsumilli et al., in a multi-camera system, differences in parallax and performance between adjacent cameras can be corrected by actively selecting the image stitching algorithm to apply based on detected image feature data.

As an alternative, U.S. Pat. No. 10,341,559 by Z. Niazi provides a multi-camera system in which a plurality of adjacent low parallax cameras are assembled together in proximity along parallel edges, to produce real-time composite panoramic images. The processes and methods to calibrate individual camera channels and their images and assemble the composite images can affect the resulting panoramic image quality or analytics.

Thus, there remain opportunities to improve the assembly of the individual and aggregated images produced by low parallax panoramic multi-camera devices. In particular, the development of improved and optimized image calibration and rendering techniques can both improve various aspects of output image quality for viewing or for analytical applications, and reduce the image processing time, to facilitate the real-time output of tiled composite panoramic images.

### BRIEF DESCRIPTION OF THE DRAWINGS

The detailed description is described with reference to the accompanying figures. The same reference numbers in different figures indicate similar or identical items.

FIG. 1 depicts a 3D view of a portion of a multi-camera capture device, and specifically two adjacent cameras thereof.

FIG. 2A depicts a cross-sectional view of an example improved imaging lens system that may be used in a multi-camera capture device.

FIG. 2B depicts a cross-sectional view of a low-parallax volume of the example imaging lens system of FIG. 2A.

FIG. 2C depicts front color at an edge of an outer lens element of the example imaging lens system of FIG. 2A.

FIG. 2D depicts a graph of parallax differences for a camera channel, relative to a center of perspective.

FIG. 3A and FIG. 3B depict fields of view for adjacent cameras, including both core and extended fields of view (FOV), useful in designing the multi-camera capture device of FIG. 1.

FIG. 4A depicts a pictorial flow diagram of an example process for generating a panoramic image using image compositing techniques, as described herein.

FIG. 4B depicts example plots characterizing an overlap area between camera channels.

FIG. 4C depicts an example process for determining weights corresponding to data from different camera channels.

FIG. 5 depicts photogrammetric image capture using multiple camera positions. FIG. 6 depicts low-parallax cameras integrated with a LIDAR laser scanning system.

FIG. 7A depicts multiple low-parallax cameras in a visor configuration.

FIG. 7B is a perspective view of an example use scenario for the visor configuration of FIG. 7A.

FIG. 8 depicts an alternate example of a multi-camera configuration.

### DETAILED DESCRIPTION

In typical use, a camera images an environment and objects therein (e.g., a scene). If the camera is moved to a different nearby location and used to capture another image of part of that same scene, both the apparent perspectives and relative positioning of the objects will change. In the latter case, one object may now partially occlude another, while a previously hidden object becomes at least partially visible. These differences in the apparent position or direction of an object are known as parallax. Parallax is the apparent displacement or difference in the apparent position of an object viewed along two different lines of sight and is measured by the angle or semi-angle of inclination between those two lines. In a panoramic image capture application, parallax differences can be regarded as an error that can complicate both image stitching and appearance, causing visual disparities, image artifacts, exposure differences, and other errors. Although the resulting images can often be successfully stitched together with image processing algorithms, the input image errors complicate and lengthen image processing time, while sometimes leaving visually obvious residual errors.

Panoramic camera images have been created by a variety of approaches. As an example, in February 2021, the Mars rover Perseverance, used a classical approach, in which a camera was physically rotated to capture 142 individual images over a 360-degree sweep, after which the images were stitched together to create a panoramic composite. For image capture of near objects, this method provides superior results when the camera rotates about its entrance pupil, which is a point on the optical axis of a lens, about which the lens may be rotated without appearing to change perspective. In most use cases, such as lenses operating in air, the entrance pupil is co-located with the front nodal point, which is co-located with the front principal point of a lens. In the field of optics, the principal points or planes of a lens system are fictitious surfaces which, to a first order of approximation, appear to do all the light ray bending of a lens when forming an image, where an entrance pupil is the optical image of the physical aperture stop, as ‘seen’ through the front (the object side) of the lens system. Real lens systems are more complex and consist of multiple offset thick lens elements, but first order approximations, using thin-lens concepts like entrance pupils and principal planes, can be useful in creating design specifications.

In recent years, systems such as the Insta360, which has multiple spatially offset cameras arrayed about a sphere, have been used to capture panoramic images. The individual cameras have significant field of view (FOV) overlap to compensate for the gaps or blind regions between offset cameras. When these images are stitched together to create a panoramic composite, the parallax differences in the overlapping fields of view complicate image stitching and create image artifacts. As a result, such image stitching can be very time consuming. In contrast, commonly assigned U.S. Pat. No. 10,341,559 by Z. Niazi provides a multi-camera system where the cameras are optically designed to reduce parallax. Niazi teaches how to design cameras where multiple cameras can be arrayed together to share a common center of perspective, referred to in the application as the No-Parallax point, thereby enabling the lenses to share a common point of view to improve the real-time assembly of the images into panoramic composites.

Panoramic depictions of an environment can be created from a collection of images from an arbitrary number of cameras at arbitrary locations. This type of situation can be fraught with challenges related to the degree of parallax between cameras of the system. Typically, adjacent cameras have significant FOV overlap between them, and then capture similar content from significantly different directions. While this can be useful for stereo vision, for panoramic viewing, significant image errors from differences in camera perspective can occur. In a high parallax system, objects closer to the cameras will occlude different portions of the scene that are farther away as seen by different cameras of the system. Adjacent, but FOV overlapped cameras with large parallax differences between them, may image different portions of an object that appear different in color or detail. Resolving these parallax induced occlusion or image difference effects can be computationally challenging and error prone.

In a multi-camera system, adjacent images captured by adjacent cameras can be assembled into a panoramic composite by image tiling, stitching, or blending. In image tiling, the adjacent images are each cropped to their predetermined FOV and then aligned together, side by side, to form a composite image. The individual images can be enhanced by intrinsic, colorimetric, and extrinsic calibrations and corrections prior to tiling. While this approach is computationally quick, image artifacts and differences can occur at or near the tiled edges.

In a low-parallax multi-camera system, the cameras can share a nominally common center of perspective, and the process of image registration is relatively straightforward, as the images are already aligned, or nearly aligned, with respect to a common center of perspective. Additionally, the overlapping FOVs are small. Low parallax and extrinsic calibration allow for very small regions of overlap in which the parallax induced affects can be negligibly small so as to be imperceptible to a visual observer (e.g., ≤3 JNDs (just noticeable differences)). There are at least 4 parameters that can degrade a composite blended or tiled image at the boundary or overlap region where two adjacent images are combined; color changes, alignment errors, missing data (optical gap), and parallax alignment differences versus depth or angle. For example, the JNDs can be used to measure local color, pattern, or content discontinuities between images of an object captured by two adjacent cameras within an overlap region. The JNDs for parallax depend on various factors including the resolution of the image, the viewing distance, and the amount of angular overlap between the images. This means that computationally simple techniques can be used to form the panoramic depiction allowing for real-time video applications.

By comparison, image stitching is the process of combining multiple images with overlapping fields of view to produce a segmented panorama or high-resolution image. Most approaches to image stitching require nearly exact overlaps between images and identical exposures to produce seamless results. For example, algorithms that combine direct pixel-to-pixel comparisons with gradient descent can be used to estimate these parameters. Distinctive features can be found in each image and then efficiently matched to rapidly establish correspondences between pairs of images. When multiple images exist in a panorama, techniques have been developed to compute a globally consistent set of alignments and to efficiently discover which images overlap one another. A final compositing surface onto which to warp or projectively transform and place all of the aligned images is needed, as are algorithms to seamlessly blend the overlapping images, even in the presence of parallax, lens distortion, scene motion, and exposure differences. However, differences in illumination and exposure, background differences, scene motion, camera performance, and parallax, can create detectable artifacts.

In greater detail, in a camera system having large parallax errors, it is impossible to merge images from multiple cameras together, even after the camera intrinsic and extrinsic relationships are known, because the field angles/pixel coordinates corresponding to objects change depending on the distance to the object. In order to determine how to stitch together imagery from multiple cameras, it is necessary to identify points in the environment common between camera images and use these points to estimate the appropriate parameters. Common methods for detecting and matching points between images include SIFT, SURF, ORB, and other similar methods. The set of commonly matched points can be used with optimization algorithms including RANSAC to estimate the locations to stitch together imagery. This can be very challenging since it requires the environment to contain image characteristics that are conducive to detecting these descriptive points and the process is sensitive to lighting variation and environments that are feature-poor.

In the case of using adjacent low-parallax cameras, parallax errors, background differences, and scene motion issues are reduced, as is the amount of FOV overlap between cameras. An intermediate process of image blending can then be advantageously used, without the larger burdens of image stitching. Image blending combines two images to ensure the same pixel values.

The form of the panoramic depiction of an environment is strongly influenced by its intended use. Virtual Reality (VR) applications allow users to wear a headset which provides the pose of the wearer's head. A portion of the panoramic depiction corresponding to the wearer's head pose is selected and displayed in the headset. This gives the user the sense of being in the environment. For these applications, it is important that the depiction of the environment is in a form that is compatible with the VR systems. Two common formats for these applications are equirectangular projection and cube map. Each of these formats stores the panorama in a form that is essentially rectangular or composed of rectangles. A cube map stores the depiction of the environment as faces of a cube surrounding the origin of the camera system. In an equirectangular projection, each pixel of the projection represents a latitude and longitude of an imaginary sphere surrounding the camera system. An important implication of these depictions is that the spatial sampling of the environment varies with the view angle. For a cube map consisting of six square images of regularly sized pixels, the pixels in the corners would subtend a different view angle than those pixels in the center of each face of the cube map. The effect is even more extreme for the equirectangular projection. The top and bottom rows of pixels would correspond to the directional view of the North and South poles respectively. In this case, the view angle varies non-isotropically, the horizontal and vertical sampling rates are very different.

Regardless of the form of the depiction, the creation and population of the pixels within the depiction is similar. First, a transparent surface is imagined surrounding the camera system. For a cube map the surface is a cube. For an equirectangular projection, the surface is a sphere. Then a mapping is created between the pixels of the storage format and the imagined surface. For a cube map, we imagine each face of the imaginary cube to be comprised of pixels. The color of each pixel is the color of the environment as seen by the camera system through that portion of the imaginary surface. For an equirectangular projection, the process is only slightly different. A rectangular image is created. Each pixel of the image corresponds to evenly spaced latitude and longitude coordinates similar to a Mercator map projection. The color of each pixel is the color of the environment as seen through the imaginary sphere at the corresponding latitude and longitude.

As will be explained in the present application, it can be desirable to use a specialized multi-camera system that is optically and opto-mechanically designed to reduce and maintain low parallax along and near adjacent camera edges (e.g., seams). In particular, for such camera systems, it can also be desirable to avoid an abrupt transition from presenting image data from one camera to presenting image data from another. The image transition from one camera source to another can be managed by a form of image rendering referred to as blending. A strategy accounting for the spatial extent of the FOV overlap regions near the scams, in which the contributions of each camera are varied to provide a smooth transition from one camera to another within these regions, can be beneficial.

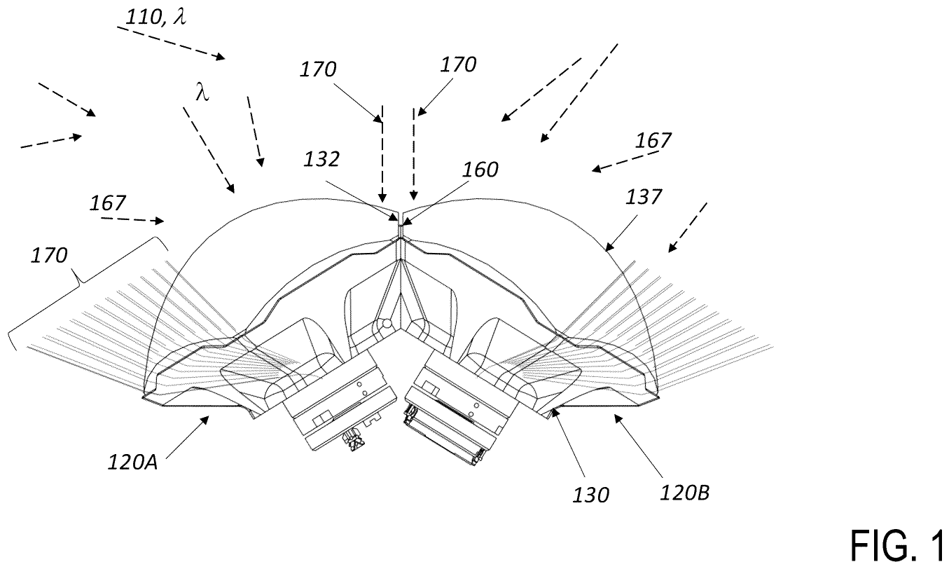

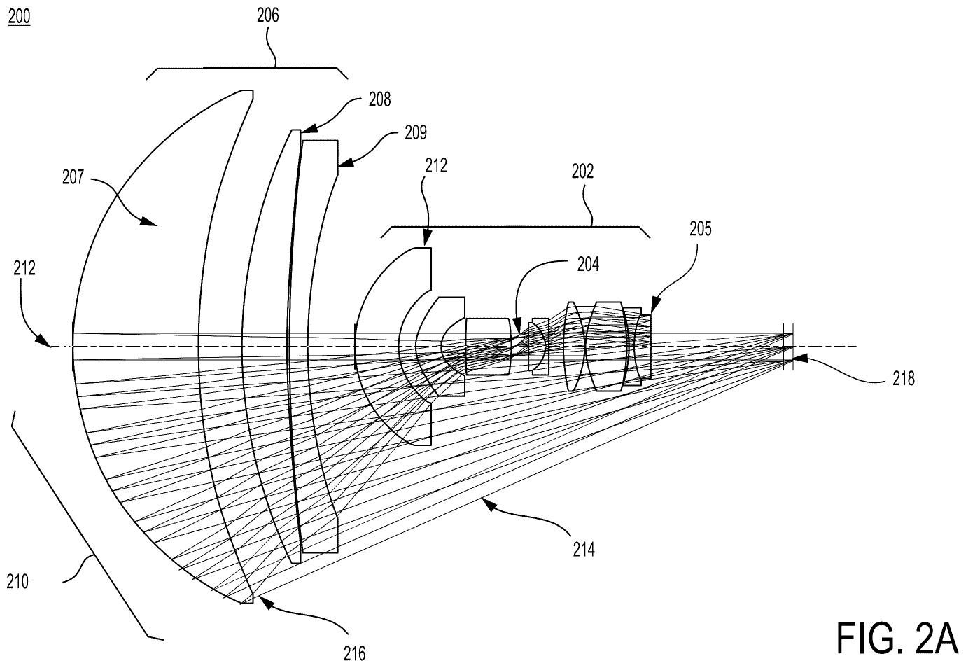

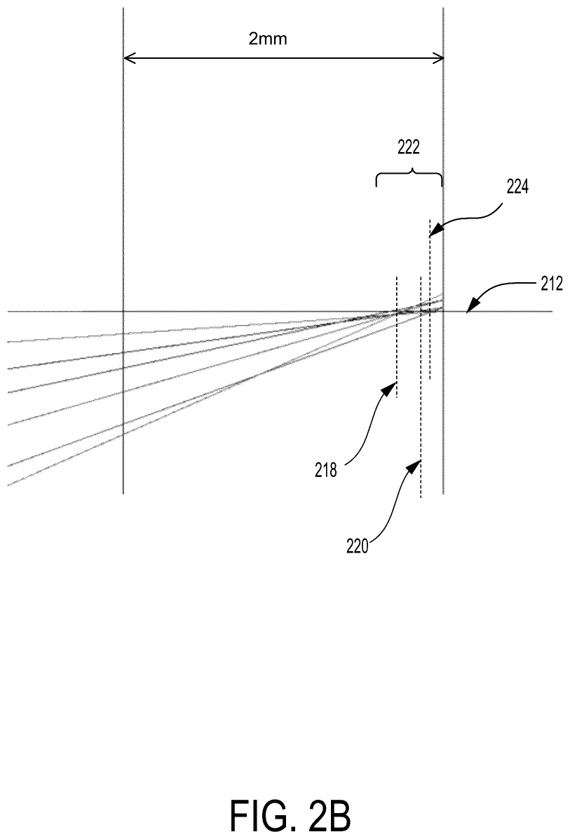

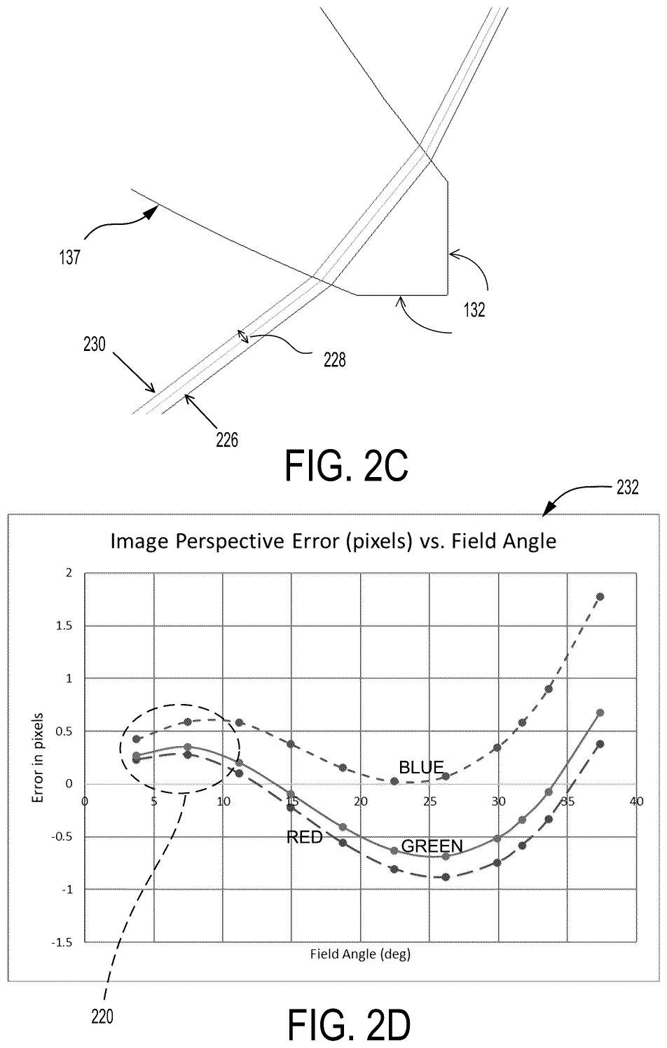

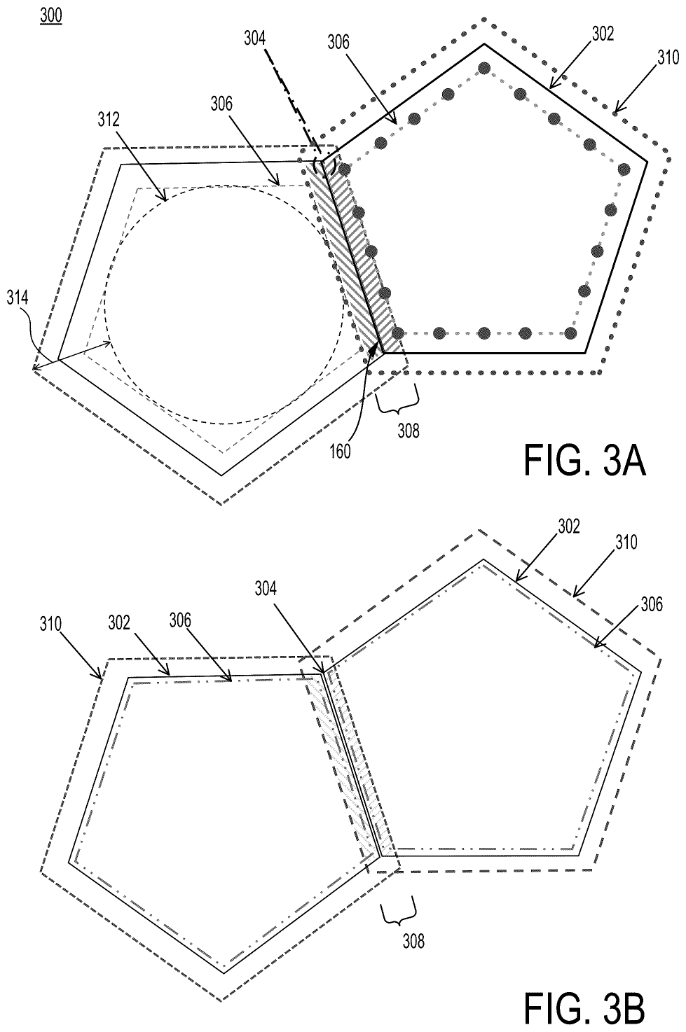

An example low-parallax multi-camera is described in U.S. Patent Application Pub. No. 2022/0357645, filed Dec. 23, 2021, the entirety of which is incorporated by reference herein for all purposes. To provide context, FIG. 1 depicts a portion of an improved integrated panoramic multi-camera capture device 100, as described in the aforementioned application. The portion illustrates two adjacent cameras 120A, 120B (collectively, the cameras 120) in lens barrels or housings 130 which are designed for reduced-parallax image capture. The cameras 120 are alternately referred to as camera channels, or objective lens systems. The cameras 120 may each have a plurality of lens elements mounted within the lens barrels or housings 130, as described further with reference to FIG. 2A. Adjacent outer lens elements 137 of the cameras 120 have adjacent beveled edges 132 and are proximately located, one camera channel to another, but which may not be in contact, and thus are separated by a mechanical gap or physical seam 160 of finite width. An optical gap, which accounts for the beveled edges 132, is larger yet. The physical seams 160 between adjacent camera channels 120 or the adjacent outer lens elements 137 can be measured in various ways: as an actual physical distance between adjacent lens elements or lens housings, as an angular extent of lost FOV, or as a number of “lost” pixels. However, the optical gap, as the distance between outer chief rays of one camera to another can be larger yet, due to any gaps in light acceptance caused by vignetting or coating limits. For example, anti-reflection (AR) coatings are not typically deposited to the edges of optics, but an offsetting margin is provided, to provide a coated clear aperture (CA). Some portion of available light (2), or light rays 110, from a scene on the long conjugate side of the lens, or in object space 105, will enter a camera 120A, 120B to become image light that was captured within a constrained field-of-view (FOV) and directed to an image plane, while other light rays will miss the cameras 120 entirely. In examples shown in FIG. 1, other portions of the available light (2) can be predominantly reflected off of the outer lens element 137. Yet other light that enters a camera 120 maybe blocked or absorbed by some combination of internal elements of the cameras 120, such as blackened areas (not shown) that are provided at or near an aperture stop, inner lens barrel surfaces, lens element edges, internal baffles or light trapping features, a field stop, or other surfaces. Some light rays 167 that are incident at large angles to the outer surface of the outer lens element 137 can transit a complex path through the lens elements of the cameras 120 and create a detectable ghost image at an image plane of the cameras 120. FIG. 1 also depicts a fan of chief rays 170, or perimeter rays, incident along or near the beveled edges 132.

The exemplary two cameras depicted in FIG. 1 may be apart of a larger system with multiple cameras arrayed in a Goldberg polyhedral geometry (e.g., dodecahedral, icosahedral). The plurality of adjacent cameras 120 can image to fill a conical FOV, a hemispherical FOV, a nearly spherical FOV, an annular FOV, or other combinations. Parallax control of adjacent cameras to each other is provided by both the lens design and the opto-mechanical design to support the plurality of camera channels in proximity with nominal parallelism along the adjacent seam edges. As an example, the multi-camera capture device 100 may be intended for 360-degree imaging and comprise eleven cameras with pentagonal imaging areas configured to capture the image data of eleven of the twelve surfaces of a dodecahedron.

Any given camera 120A, 120B in the integrated panoramic multi-camera capture device 100 can have a boresight error such that the camera captures an angularly skewed or asymmetrical FOV (FOV↔) or mis-sized FOV (FOV±). The lens pointing variations can occur during fabrication of the camera (e.g., lens elements, sensor, and housing) or during the combined assembly of the multiple cameras into an integrated panoramic multi-camera capture device 100, such that the alignment of the individual cameras is skewed by misalignments or mounting stresses. When these camera pointing errors are combined with the presence of the seams 160 between the cameras 120, images for portions of an available landscape or panoramic FOV that may be captured, may instead be missed, or captured improperly. The variabilities of the camera pointing, and seams can be exacerbated by mechanical shifts and distortions that are caused by internal or external environmental factors, such as temperature, vibration, or light (e.g., solar radiation), and particularly asymmetrical loads thereof. The camera assembly, alignment, and calibration processes can mitigate these effects. For example, intrinsic calibration can be used to find the effective optical axis with boresight error, while extrinsic calibration may compensate to a global geometry.

In comparison to the device 100 of FIG. 1, in a typical commercially available panoramic camera, the seams between cameras are outright gaps that can be 30-50 mm wide, or more, depending on the size of the cameras. In particular, such a panoramic camera can have adjacent cameras or camera channels separated by large gaps or seams, between which there are blind spots or regions from which neither camera can capture images.

When designing a lens system for an improved low-parallax multi-camera panoramic capture device (such as the device 100), there are several factors that affect performance (including, particularly parallax) and several parameters that can be individually or collectively optimized, so as to control it. One approach for parallax control during lens optimization targets the “NP” point, or more significantly, variants thereof. As background, in the field of optics, there is a concept of the entrance pupil, which is a projected image of the aperture stop as seen from object space, or a virtual aperture which the imaged light rays from object space appear to propagate towards before any refraction by the first lens element. By standard practice, the location of the entrance pupil can be found by identifying a paraxial chief ray from the object space 105, that transits through the center of the aperture stop, and projecting or extending its object space direction forward to the location where it hits the optical axis of the camera 120. In optics, incident Gauss or paraxial rays are generally understood to reside within an angular range less than or equal to 10° from the optical axis, and correspond to rays that are directed towards the center of the aperture stop, and which also define the entrance pupil position. Depending on the lens properties, the entrance pupil may be bigger or smaller than the aperture stop, and located in front of, or behind, the aperture stop.

By comparison, in the field of low-parallax cameras, there is a concept of a no-parallax (NP) point, or viewpoint center. Conceptually, an NP point associated with the paraxial entrance pupil can be helpful in developing initial specifications for designing the lens, and for describing the lens. Whereas an NP point associated with non-paraxial edge of field chief rays can be useful in targeting and understanding parallax performance and in defining the conical volume or frustum that the lens assembly can reside in. The projection of chief rays, and particularly non-paraxial chief rays can miss the paraxial chief ray defined entrance pupil because of both lens aberrations and practical geometry related factors associated with these lens systems, the principal cause being pupil spherical aberration (PSA). Relative to the former, in a well-designed lens, image quality at an image plane is typically prioritized by limiting the impact of aberrations on resolution, telecentricity, and other attributes. Within a lens system, aberrations at interim surfaces, including the aperture stop, can vary widely, as the emphasis is on the net sums at the image plane. Aberrations at the aperture stop are often somewhat controlled to avoid vignetting, but an aberrated non-paraxial chief ray need not transit the center of the aperture stop or the projected paraxially located entrance pupil.

The resultant image quality from the cameras 120 will also depend on the light that scatters at surfaces, or within the lens elements, and on the light that is reflected or transmitted at each lens surface. The surface transmittance and camera lens system efficiency can be improved by the use of anti-reflection (AR) coatings. The image quality can also depend on the outcomes of non-image light. The aggregate image quality obtained by a plurality of adjacent cameras, such as the cameras 120, within an improved integrated panoramic multi-camera capture device 100 can also depend upon a variety of other factors including the camera-to-camera variations in the focal length and/or track length, and magnification, provided by the individual cameras. These parameters can vary depending on factors including the variations of the glass refractive indices, variations in lens element thicknesses and curvatures, and variations in lens element mounting. As an example, images that are tiled or mosaiced together from a plurality of adjacent cameras will typically need to be corrected, one to the other, to compensate for image size variations that originate with camera magnification differences (e.g., ±2%).

FIG. 2A depicts an example of a complete low-parallax lens system 200, including lens elements of a wide-angle group 202 that are located about an aperture stop 204, and lens elements of a compressor group 206, mounted in a housing (not shown) within a portion of the multi-camera capture device 100. In the camera lens design depicted in FIG. 2A, an outer lens element 207, a second compressor lens element 208 and a third compressor lens element 209 of the compressor group 206 redirects the transiting image light, such as chief rays 210 towards a lens element 212, which may have a very concave shape similar to an outer lens element used in a fish-eye type imaging lens and comprises the first lens element of the wide-angle group 202. The image light is refracted and transmitted through lenses of the wide-angle group 202, through the aperture stop 204, and converges to a focused image at or near an image plane 205, where an image sensor (not shown) is typically located. FIG. 2A also depicts virtual projections 214 of edge-of-field chief rays 216, directed towards edge chief ray NP point 218 located behind both the aperture stop 204 and the image plane 205.

The compressor group 206 of lens elements directs the image light 210 sharply inwards, or bends the light rays, toward an optical axis 212 of the lens system 200, to both help enable the overall lens system 200 to provide a short focal length, while also enabling the needed room for mechanical features necessary to both hold or mount the lens elements 202, 206, and to interface properly with the barrel or housing of an adjacent camera. In some examples, the cameras 120 can be designed with the lens system 200 that supports an image resolution of 20-30 pixels/degree, to as much as 110 pixels/degree, or greater, depending on the application and the device configuration. As an example, the lens system 200 may have a maximum field of view of ˜24 deg. In some examples, objective lenses of the lens system 200 may comprise 11 lens elements. For example, elements 1-3 may be plastic (E48R, E48R, OKPA2), element 5 may have an aspheric and a conic surface, and elements 9-10 may have one aspheric surface each. In some examples, the lens system 200 may have a focal length of 14.9 mm and an aperture of F/2.8, a half field of view is 23.8°, and may support an image semi-diagonal of 6.55 mm. In some examples, a track length of the lens system 200 may be 119.7 mm, and a LP-smudge may be located about 29.2 mm behind the image sensor or image plane 205.

FIG. 2B shows chief rays across all fields in the vicinity of the paraxial entrance pupil or paraxial NP point 220 for the example objective lens system 200 of FIG. 2A. The design of the lens system 200 can be optimized to position the geometric center of the device 100 outside, but proximate to a low-parallax volume or LP-smudge volume 222, or alternately within it, and preferably proximate to a non-paraxial chief ray NP point. In this case, the LP-smudge volume 222 is very small and shows little shift in position (crossing of the optical axis 212) with field. This results in very low residual angular parallax within the field of view of this lens, of less than 0.03° for green light, and less than 0.07° for either red or blue light. The paraxial (220), mid field (218), and edge of field (224) NP points are tightly clustered, although there are subtle variations therein. For example, edge of field chief rays converge to different NP point 224 depending on where they are in angle or position along the edge. This variation is described in further detail with reference to FIG. 2D, where the residual parallax can vary by fractions of a pixel, versus field angle along a polygonal lens edge. Relative to calibration, target, or nominal values for intrinsic, radiometric, or chromatic calibration, are known. For example, distortion is less than 1.3% across the entire imaged field of view. Lateral color, at less than 0.7 μm, is sub-pixel. Corrected front color, at less than or equal to 0.2 mm between red and blue light, is small compared to the estimated geometric beam size on the first compressor lens element of 6.5 mm. Image resolution, as measured by MTF, is greater than 40% for all fields at 200 lp/mm. Relative illumination (RI) at the edge of the imaged field is about 75%.

As another aspect of the example lens system 200, FIG. 2C depicts “front color,” which is defined as a difference in the nominal ray height at the fist lens surface between colors versus field, as directed to an off axis or edge field point (usually the maximum field). Typically, for a given field point, the blue light rays are the furthest offset. As shown in FIG. 2C, an accepted blue ray 226 on a first lens element 137 is a width 228 ΔX≈1 mm further out than an accepted red ray 230 directed to the same image field point. If the lens element 137 or 207 is not large enough, then this blue light can be clipped or vignetted, and a color shading artifact can occur at or near the edges of the imaged field. Front color can appear in captured image content as a narrow rainbow-like outline of the polygonal FOV or the polygonal edge of an outer compressor lens element which acts as a field stop for the optical system. Localized color transmission differences that can cause front color related color shading artifacts near the image edges can be caused by differential vignetting at the beveled edges of the outer compressor lens element 137, or from edge truncation at compressor lens elements, or through the aperture stop 145. During lens design optimization to provide the lens system 200, front color can be reduced (e.g., to the width 228 ΔX (B−R) less than or equal to 0.5 mm width) as part of the chromatic correction of the lens design, including by glass selection within the compressor lens group or the entire lens design, or as a trade-off in the correction of lateral color. Front color is related to a term used in the field as longitudinal color of the entrance pupil, and similar to spherical pupil aberration it is an aberration whereby multiple colors of light projected into the lens system appear to project to different places along the optical axis. Front Color can be reduced by glass selection within the compressor lens group pre aperture stop, including by use of a doublet or triplet within a pre-stop lens group. In some designs, front color and image plane lateral color optimization can be a trade-off.

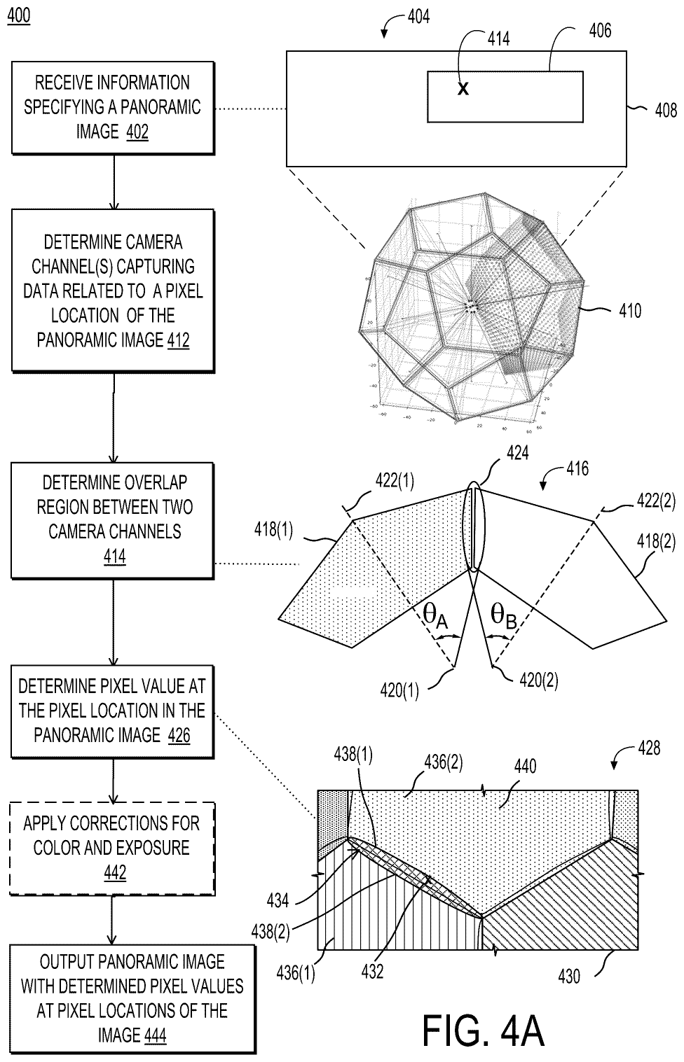

The effect of front color on captured images can also be reduced optomechanically, by designing the lens system 200 to have an extended FOV, as described with reference to FIG. 3A, and also the opto-mechanics to push straight cut or beveled lens edges 132 at or beyond the edge of the extended FOV, so that any residual front color occurs outside the core FOV. Any residual front color artifact can then be eliminated during an image cropping step during image processing.

FIG. 2D depicts a graph of a variation in parallax or the center of perspective, as an error or difference in image pixels versus field angle and color (R, G, B) for a low-parallax lens system e.g., the lens system 200. In an example graph 232 shown, two objects are imaged, one at a 3-foot distance from a low-parallax multi-camera panoramic capture device, such as the device 100, having an improved low-parallax camera lenses, such as the lens system 200, and the other object at an “infinite” (∞) distance from the device. The example 232 shows parallax errors of <1 pixel for red and green, and ˜1.5 pixels in blue, from on axis, to nearly the edge of the field (e.g., to ˜34 deg.). Parallax errors can also be quantified in angles (e.g., fractions of a degree per color). Although the R, G, B curves of center of parallax or perspective difference have similar shapes due to parallax optimization, there are small offset and slope differences between them. These differences are expressions of the previously discussed residual differences spherochromatism of the entrance pupil. The parallax errors for blue light can exceed 1.5 pixels out at the extreme field points (e.g., the vertices). However, limiting perspective or parallax errors further, to sub-pixel levels (e.g., less than or equal to 0.5 pixel) for imaging within the designed FOVs, and particularly within the peripheral fields, for at least green light, is preferable, particularly for near imaging applications. If the residual parallax errors between adjacent cameras are small enough (e.g., ≤3-4 pixels), the captured images obtained from the core FOVs can be readily and quickly cropped and tiled together. Likewise, if the residual parallax errors within the extended FOVs that capture content in or near the seams are similarly small enough, and the two adjacent cameras are appropriately aligned to one another, then the overlapped captured image content by the two cameras can be quickly cropped, or locally averaged or blended together, and included in the output panoramic images.

The low-parallax smudge volume 222 of FIG. 2B, and the curves of FIG. 2D, illustrate that the paraxial entrance pupils 220, are axially offset along the optical axis 212 from the NP points locations corresponding to at least some combination of the non-paraxial, mid field or edge of field, chief rays, and that there are also residual positional differences amongst these non-paraxial rays. Depending on the lens design and the image sensor choice, these differences in residual parallax of perspective error may be fractions of a pixel (e.g., as shown in FIG. 2D) or several pixels in magnitude. In optical terms, one meaning is that the paraxial and non-paraxial entrance pupils are non-identical in a meaningful way. In software calibration terms, this means that there are variations from the ideal fixed virtual pinhole assumption that can have significant impact on image calibration and re-projection error estimation. However, these low-parallax lenses (e.g., as shown in FIG. 2A), with their residual differences in the non-paraxial entrance pupils, or NP points, or virtual pinholes, optimized to benefit the chief rays along a polygonal outer lens element edge, are significantly different than both normal lenses and fisheye lenses, the latter having high distortion, very large fields of view, and spatially shifting non-paraxial “entrance pupils” located near the front of the lens, before the aperture stop.

For the example lens system 200 shown in FIG. 2A, the off-axis (e.g., full field) NP point, COP, or LP smudge has been optimized to be located behind the image plane. However, for imaging lenses designed to image objects at larger long conjugate distances (e.g., miles away), the offset of the COP to the geometric camera center can increase. In such circumstances, the COP can shift close to the image plane, or even in front of it (e.g., by 5 mm), while the PSA is still acceptably small. Whereas, if the PSA is near zero, and the COP is at or near the camera system's geometric center, the compressor lens can nearly touch the adjacent compressor lens, with little or no physical gap or seam between them. While the PSA can be optimized through lens optimization to be acceptably small, the width of the XFOV and the COP offset from the system's geometric center are typically determined from mechanical camera features (e.g., tolerances and physical widths of sensor boards or lens housings).

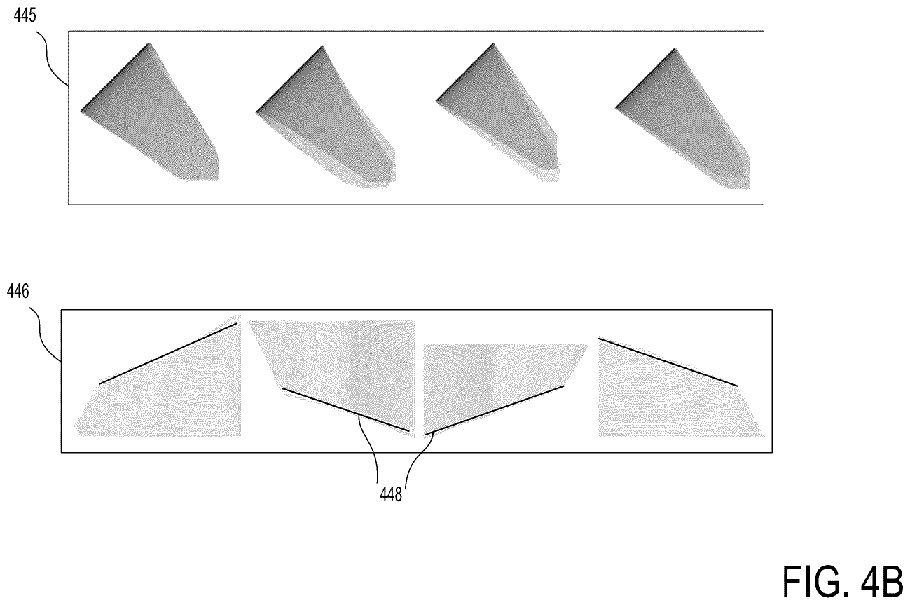

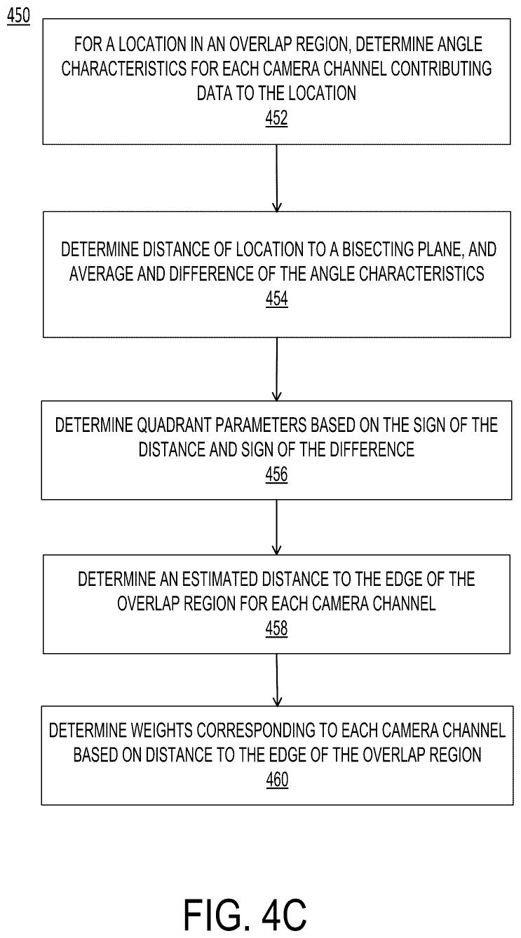

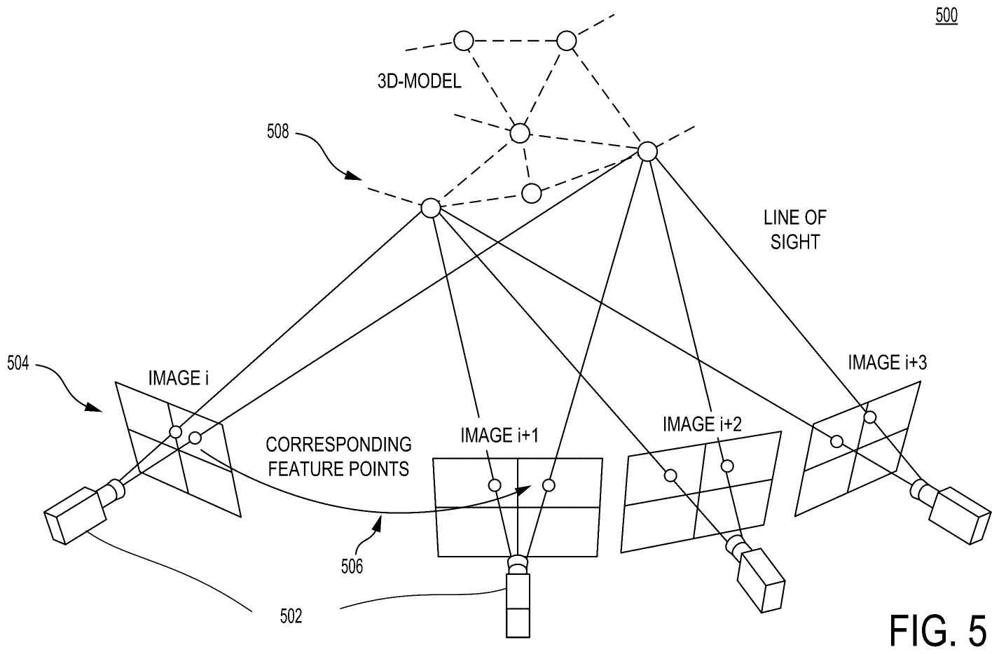

Whether the low-parallax lens design and optimization method uses operands based on chief ray constraints or spherical aberration of the entrance pupil (PSA), the resulting data can also be analyzed relative to changes in imaging perspective. In particular, parallax errors versus field and color, which can be referred to as spherochromatism of the pupil (SCPA), can also be analyzed using calculations of the Center of Perspective (COP). The COP is a point to which imaged chief rays from object space appear to converge to, in a similar manner to the concept of perspective in drawing and architecture. It is a geometric condition that for any two objects that are connected by this chief ray they will show no perspective errors. For all other fields the two objects above will show parallax in the image when they are rotated about the COP. It is convenient to choose the field which defines the COP to be important within the geometry of the camera. However, as evidenced by the perspective or parallax curves of FIG. 4D, there are residual variations in an optimized lens. Thus, the COP can be the location of an NP point for a given field where its projected chief ray crosses the optic axis. More broadly, the COP can be measured with a center of mass for a projection of chief rays, or an average location along the optical axis for all chief ray projections in a ray bundle.

Perspective works by representing the light that passes from a scene through an imaginary rectangle (realized as the plane of the illustration), to a viewer's eye, as if the viewer were looking through a window and painting what is seen directly onto the windowpane. In drawings and architecture, for illustrations with linear or point perspective, objects appear smaller as their distance from the observer increases. In a stereoscopic image capture or projection, with a pair of adjacent optical systems, perspective is a visual cue, along with dual view parallax, shadowing, and occlusion, that can provide a sense of depth. In the case of image capture by a pair of adjacent cameras with at least partially overlapping fields of view, parallax image differences are a cue for stereo image perception, or are an error for panoramic image assembly.

Analytically, the chief ray data from a real lens can also be expressed in terms of perspective error, including chromatic errors, as a function of field angle. Perspective error can then be analyzed as a position error at the image between two objects located at different distances or directions. Perspective errors can depend on the choice of COP location, the angle within the imaged FOV, and chromatic errors. For example, it can be useful to prioritize a COP so as to minimize green perspective errors. Perspective differences or parallax errors can be reduced by optimizing a chromatic axial position (Δz) or width within an LP volume 188 related to a center of perspective for one or more field angles within an imaged FOV. The center of perspective can also be graphed and analyzed as a family of curves, per color, of the Z (axial) intercept position (distance in mm) versus field angle. Alternately, to get a better idea of what a captured image will look like, the COP can be graphed and analyzed as a family of curves for a camera system, as a parallax error in image pixels, per color, versus field.

Optical performance at or near the seams 160 of the device 100 can also be understood, in part, relative to a set of defined fields of view 300, as illustrated in FIG. 3A. In particular, FIG. 3A depicts potential sets of fields of view 300 for which potential image light can be collected by two adjacent cameras. As an example, a camera with a pentagonal shaped outer lens element, whether associated with a dodecahedron or truncated icosahedron or other polygonal lens camera assembly, with the seam 160 separating it from an adjacent lens or camera channel, can image an ideal FOV 302 that extends out to the vertices 304 or to the polygonal edges of the frustum or conical volume that the lens resides in. However, because of the various physical limitations that can occur in the camera systems (e.g., offset COPS) or at the seams, including the finite thicknesses of the lens housings, the physical aspects of the beveled lens element edges, mechanical wedge, and tolerances, a smaller core FOV 306 of transiting image light can actually be imaged. The coated clear aperture for the outer lens elements 137 may encompass at least the core FOV 306 with some margin (e.g., 0.5-1.0 mm). As the lens can be fabricated with anti-reflection (AR) coatings before beveling, the coatings can extend out to the seams. The core FOV 306 can be defined as the largest un-vignetted low-parallax field of view that a given real camera can image along a polygonal lens edge. Equivalently, the core FOV 306 can be defined as the sub-FOV of a camera channel whose boundaries are nominally parallel to the boundaries of its polygonal cone. Ideally, as shown in FIG. 3B, with small seams 160, and proper control and calibration of FOV pointing, the nominal core FOV 306 approaches or matches the ideal FOV 302 in size, and an overlap region 308 can extend into an adjacent camera's core FOV.

To compensate for any blind regions, and the associated loss of image content from a scene, the cameras can be designed to support an extended FOV 310, which can provide enough extra FOV to account for the seam width and tolerances. As shown in FIG. 3A, the extended FOV 310 can extend far enough so that the overlap region 308 includes the edge of the core FOV 306 of an adjacent camera, although the extended FOVs 310 can be larger yet. This limited image overlap can result in a modest amount of image resolution loss, parallax errors, but it can also help reduce the apparent width of seams and blind regions. If the extra overlap FOV is modest (e.g., less than or equal to 5%) and the residual parallax errors therein are small enough (e.g. less than or equal to 0.75-pixel perspective error), as provided by the present approach, then the image processing burden can be very modest. For example, images in the overlap region can be blended or merged together in real time with residual parallax differences that are essentially imperceptible to a viewer (e.g., ≤2-3 JNDs). Image capture out to an extended FOV 310 can also be used to enable an interim capture step that supports camera calibration and image corrections during the operation of the multi-camera capture device 100 with the improved lens system 200, as it is advantageous when performing extrinsic calibration between cameras to have some overlap where the cameras image common features.

### Camera Calibration

In examples of the present disclosure, panoramic images may be generated from image data captured by a low-parallax, multi-camera device, such as the device 100. Such a device requires geometric camera calibration of the multiple camera channels of the device. Geometric camera calibration may include determining intrinsic and extrinsic parameters of a camera, which describe the camera's internal properties and its position and orientation in the world, respectively. The intrinsic parameters of a camera describe the internal properties of each camera channel, such as its focal length, optical center, and a description of the non-linear distortion created by the lens system. They determine how a 3D point within the field of view of the camera is projected into the 2D image coordinates captured by the image sensor. The extrinsic parameters of a camera describe the position and orientation, or pose, of the camera channel in the world, relative to a reference world coordinate system. This includes the camera's position and orientation in terms of its translation and rotation relative to the world coordinate system. Together these form a mathematical model used to relate 3D coordinates in the real world to 2D image coordinates captured by camera.

In examples, it is convenient to model the camera as an idealized pinhole through which light from a scene being captured passes without diffraction to form an inverted image on the image sensor. The advantage of such a model is that the camera can be described using a very simple linear mathematical model. However, real world optics have non-linear distortion characteristics that must be accounted for. Thus, the intrinsic calibration model typically consists of two parts. The first part comprises a simple 3×3 matrix describing a linear pinhole model. The second part is a set of distortion coefficients of an equation that describes the sagittal and tangential distortions introduced by the lens system.

The intrinsic calibration process can be described by a series of equations, that describe the projection of points in the real world onto an image sensor. For example, a matrix equation describes the transformation of a point in real world coordinates to the coordinate system of the camera. Subsequent equations are applied to convert the point into a two-dimension homogeneous vector. The distortion model uses even powers of the radial distance from the optical axis of the imaging system. A next equation describes the square of the radial distance, which is then used to calculate a sagittal distortion as a function of radial distance. Subsequent equations are used to combine the sagittal with tangential distortion terms. A matrix equation can then be used to model projective keystone distortion created when the sensor is mounted such that it is tilted away from the optical axis of the lens system, in which the calculated values for sagittal and tangential distortion are transformed and subsequently normalized. Finally, the linear pinhole camera model is applied, resulting in image sensor pixel coordinates.

In some examples, the calculation of an intrinsic calibration model requires capturing images of a scene containing known points that are readily detectable in the resulting image. A correspondence relationship must be made between points on the target and detected points in the image. In practice, this is done by capturing images of a planar target containing a pattern such as a checkerboard or a grid of dots. Henceforth, these points may be referred to as fiducial points or simply as fiducials, which are used as a fixed basis of reference or comparison. A person skilled in the art will recognize that many types of readily detectable points can be employed effectively. To determine the intrinsic calibration parameters of a camera the user must capture multiple images of a planar target pattern. The target pattern is articulated at various angles and locations within the field of view of the camera. Several algorithms can be employed to determine the parameters of the intrinsic model, and implementations of these algorithms are readily available in various software packages e.g., Matlab's camera calibration toolbox, OpenCV's camera calibration module, etc.

In some examples, the planar target may comprise an array of fuzzy dot fiducials, black on white, with hard outer edges, then transitioning to a ball point pen-like rounded top. An example method of intrinsic calibration using such a target may include: (i) drawing a region-of-interest (ROI) around a fuzzy dot, (ii) scaling the ROI to cover the entire range of pixel intensity values (e.g., 0-255), (ii) measuring an average intensity at four corners of the ROI and intensity and positions of pixels within the dot, (iv) calculating a centroid of the dot based on the measurements, (v) repeating for other fuzzy dots on the planar target, and (vi) calculating overall positions of the dots. Such a target may be displayed on a large monitor viewable by the image capture device.

In the model described above, the linear portion treats that lens as a pinhole having a constant location with respect to the image plane. In practice however, due to spherochromatic pupil aberration (SCPA), this pinhole location varies as a function of both field angle and color. In order to minimize the impact of SCPA on RMS reprojection error, the pinhole can be modelled as a moving pinhole which varies as a function of field angle. During camera intrinsic parameter optimization, the ideal pinhole for each chief ray can be determined to best model the actual SCPA of the lens system. This customized calibration approach can be used to minimize reprojection errors for low-parallax multi-camera devices (such as the device 100) using lenses such as the lens system 200, as described herein.

To allow the pinhole to vary as a function of field angle, one can use a non-standard camera model that includes the field angle as a variable. This type of model can be made to represent the pinhole as a function of field angle, allowing the pinhole to move with respect to field angle. One way to model the pinhole's movement is to use a polynomial or a spline curve to describe its position as a function of field angle. Initial parameters can be applied for the curve using the data for a lens's residual SCPA or center of perspective (COP) curves (e.g., graph 232 of FIG. 2D). If a polynomial curve fit is used, the initial parameters can be coefficients of the polynomial that model the SCPA curves for either one wavelength (e.g., green), or as a function of wavelength (R,G,B). If a spline curve is used, the initial parameters can be knots and control points, taking a series of field angles and their projected location along the optical axis, to define the shape of the spline. To optimize the curve, the Levenberg-Marquardt (LM) algorithm can be used, using the RMS reprojection error as the cost function to be optimized. Allowing the pinhole to move as a function of field angle can reduce the RMS reprojection error as compared to a static pinhole model, but it will increase the complexity of the camera model and increase the computational resources required.

It is noted that camera calibration typically also accounts for other intrinsic parameters, which are intrinsic to the camera optics, to the optical design or the fabrication realities thereof, but which are not identified as “Intrinsics” in the field of geometric camera calibration and the enabling software. These other camera calibration factors account for radiometric, photometric, or chromatic differences in lens performance, including variations in MTF or resolution from aberrations and internal lens assembly and sensor alignment variations, thermal response variations, relative illumination (RI) and vignetting, sensor quantum efficiency (Qeff) differences, and other factors.

When building a multi-camera device, such as the device 100 described herein, one must incorporate knowledge of the intrinsic model for each camera channel of the device 100, as well as corresponding extrinsic models that relate the camera channels 120 of the device 100 to each other in order to record the appearance the environment surrounding the device. The intrinsic parameters of each camera channel, the corresponding extrinsic models as described below, as well as the other camera calibration factors are together referred to as camera configuration data of the device 100.

Creating the extrinsic models for camera channels in the multi-camera device 100 can be very challenging due to the wide field of view and the number of camera-to-camera positional relationships that must be determined. A direct approach to solving this problem is to rigidly mount the cameras into a fixture such that they do not move relative to each other. This creates a camera system that can be moved in the environment while maintaining the spatial relationships between the camera channels of the device. The camera system can then be placed in an environment containing detectable real-world fiducial points for which the spatial coordinates are known. If enough fiducials are detectable by each camera of the system, then the location and attitude of the camera within the environment can be estimated. The location can be expressed as the X, Y, and Z location of the pinhole of the linear portion of the intrinsic model. The attitude can be expressed by the roll, pitch, and yaw angles of the camera channels within the environment. Once the location and attitude are estimated for each camera channel of the device 100, then their relationships to each other can be calculated. Once the extrinsic relationships between the cameras is known, the device 100 can be moved to an arbitrary environment and a depiction of the new environment can be recorded.

However, this method of extrinsic calibration can be expensive and inconvenient. It requires that a special environment be constructed with carefully measured fiducial locations. This environment must be large enough to accommodate the focal distance of the camera channels of the device and must be dedicated to the task of extrinsic calibration. Typically, this would entail dedicating an entire large room for this process. Such a method is not portable and is subject to difficulties of protecting the environment from contamination and degradation.

An alternative extrinsic calibration method entails discovering the spatial relationship between camera channel pairs of the device 100. Using a target pattern with a set of detectable fiducials that spans the fields of view of two camera channels (e.g., camera channels 120A, 120B), the relationship between the two camera channels can be estimated. In some examples, a very large target pattern may be used, such that one end of the pattern is within the field of view of a first camera channel, and the other end is within the field of view of an adjacent camera. Then, the location of each camera channel can be estimated relative to the target pattern. By association, the position of the camera channels relative to each other can be calculated. This method does not require any field-of-view (FOV) overlap between adjacent camera channels but having such an overlap (e.g., ≤1 degree) can be very useful in verifying the accuracy of the extrinsic relationship. Once the relationship between camera channel pairs is known, these relationships can be combined by association to create an overall model of the camera channels relative to one another.

This method of extrinsic calibration has several advantages. For example, the calibration can be done with a single target pattern, and the calibration target pattern can be relatively small and portable, allowing for the calibration to be performed at multiple locations including at locations where the device 100 is used. Because of their size and simplicity, the calibration targets can be much less expensive than a dedicated environment. For example, if planar targets are used, they can simply be stacked and stored.

However, using this method of extrinsic calibration, each estimation of the position of a camera relative to a target pattern may vary slightly due to image noise and slight imprecisions in the detected locations of fiducials in the image. Thus, each estimate of the relative position of camera channel pairs may vary slightly due to these factors. If the device 100 is assembled by registering channel A to channel B, channel B to channel C, etc., up to channel N, then the small errors can propagate and accumulate. If there is a loop closure in the system such that channel N is adjacent to channel A, then the propagated relationship between channel N and channel A may differ significantly from the directly estimated relationship between these adjacent channels.

Several techniques can be employed to minimize the impact of the noise and imprecision that contributes to the error in estimating the relative positions of pairs of channels. For example, if the calibration targets contain many densely packed fiducial points, then statistical analysis can be employed to identify specific fiducial points whose reprojection errors make them outliers. These outlier points can be de-emphasized in the extrinsic calibration calculations or can be excluded altogether. Since regions of overlap are visually very important in the constructed depiction of the wide field of view, fiducials in these areas can receive increased emphasis. The relationship between channel pairs can be repeatedly estimated using multiple target captures. These results can be averaged and reprojection errors of each estimate can be used to weight the contribution of the estimate or eliminate an estimate altogether.

After completion of intrinsic and extrinsic calibration, pixels on the image sensor corresponding to parallel chief rays in object space can be determined and mapped to a common boundary on the projected image, using a calibration resolution to reveal the residual parallax differences along the edges of the outer front lens elements. The residual differences in parallax or perspective, remaining after lens design optimization to control SCPA, can be represented by a curve fit to the modeled center of perspective (COP) curved for that lens.

Relative to the present system with lenses designed to control parallax and perspective errors with a limited extended FOV or overlap region, image stitching is nominally unnecessary. But there is value in applying an optimized image blending method, as described with reference to FIGS. 4A and 4B. Image blending particularly has value when the overlap region 308 spans from near the edges of an extended FOV 310 into the core FOVs 306 of the adjacent cameras (e.g., as shown in FIG. 3B). Again, in examples, it may be preferable to have the extended FOV 310 be larger than the core FOV 306 by ≤1°, although the overlap region can be larger yet (in degrees or pixels). After image blending is completed, the images can be further cropped down from the size of the extended FOV 310 to the core FOV 306, and then aligned and abutted or tiled to form a composite image.

In examples, the multi-camera device 100 may be designed so that a small, but significant area of overlap exists between adjacent cameras. This region provides tolerance for the mechanical alignment of the cameras of the device and a basis for balancing exposure across all the camera channels in the device. In examples of the present disclosure, panoramic images (e.g., using equirectangular projections) may be generated from image data captured by multiple camera channels corresponding to the cameras of the multi-camera device 100. In such panoramic images, pixel values in the overlap regions between camera channels may be determined by blending the image data from different cameras to smoothly transition between cameras as the view traverses the overlap region. For example, the contribution of each camera channel to the pixel values in the overlap region may be varied such that there is a smooth transition from one camera to another within these regions.

FIG. 4A is a pictorial flow diagram illustrating an example process 400 for generating a panoramic image from a plurality of images of a scene as captured multi-camera system. In particular, the process 400 may be utilized for blending images in a region of overlap between camera channels. In examples of this disclosure, the multi-camera system may be a low-parallax camera system such as the device 100 of FIG. 1.

At an operation 402, the process 400 may include receiving information specifying a panoramic image to be generated. As shown in an example 404, a panoramic image 406 may be specified by indicating an extent covered by the panoramic image 406 within a projection image 408 of the scene captured by the multi-camera system. The panoramic image 406 may be specified as an equirectangular projection, creating a rectangular image as shown. In other examples, the panoramic image 406 may be represented as a cube map. In the example 404, the multi-camera system may be represented by an idealized dodecahedral projection geometry 410, where each face of the dodecahedron represents a camera channel. The projection geometry may be used to convert input data from multiple camera channels of the multi-camera system to the output format of the panoramic image 406. For example, the input data may be in a spherical format (e.g., a near 360-degree image) matching the multi-camera system geometry (e.g., dodecahedral), and the equirectangular output format 408 may be obtained by a projection (e.g., Mercator projection) of the input data into the final format desired (e.g., equirectangular).

In some examples, the conversion from the spherical format to the equirectangular format may be accomplished by iterating over every pixel of an output equirectangular image, such as the panoramic image 406 or the entire projection image 408. For example, for each pixel of the equirectangular image, the angle (theta and phi) the pixel corresponds to is determined by mathematically projecting the pixel location as a ray vector piercing the ideal dodecahedron corresponding to the input format. As a result, ray vector data can be determined for every pixel as pinhole location [x,y,z] and angle [theta, phi]. Where a ray vector intercepts a field-of-view (FOV) of only one camera channel, the process 400 may output the pixel value from the image data of the one camera channel directly onto the equirectangular image 408. It is noted that the pixel values of the image data may be modified by the predetermined radiometric, photometric, and geometric (intrinsic and extrinsic) calibration values associated with the camera channel. For example, a chromatic response of each camera channel may be determined during a factory calibration process. As an example, light from a nominally uniform white light source can be projected over the entire field of view. If the entire FOV is not covered, multiple images may be tiled together. The chromatic response of the camera channel may be measured to correct for color response and vignetting throughout the FOV. The chromatic response can be stored in a 3×3 matrix that may be later used to correct for vignetting and color response in real-time for each pixel.

At an operation 412, the process 400 may include determining camera channel(s) capturing data related to a pixel location of the panoramic image 406, such as the pixel location 414. The camera channel(s) which have valid image data to contribute to the projection at the pixel location 114 may be determined when creating the equirectangular projection 408 from the image data captured by the camera channel(s) of the multi-camera system, as described above. As another example, the pixel location 414 may be mapped (e.g., as a latitude and longitude) to the spherical format of the dodecahedral geometry 410, and the camera channel(s) determined as those camera channel(s) whose field-of-view (FOV) include the mapped location of the pixel location 414. In the example multi-camera device 100, if the pixel location 114 is within an area of overlap, then up to three camera channels may capture image data corresponding to the pixel location 114. However, with other multi-camera configurations, the number of cameral channels with overlapping image data in overlap regions may vary.

In some examples, the residual parallax and perspective differences across a projection geometry, such as the dodecahedral geometry 410, can be used to modify a vector space mapping, based on the LP smudge information (as shown in FIG. 2B) which provides knowledge over every pixel, and where it nominally maps in object space, to very small error. In one sense, by designing these lenses to limit parallax, an end result is to make these cameras closer to the software idealization. However, for pertinent applications, the data for the known variation in residual parallax or perspective error (e.g., graph 232 as shown in FIG. 2D) for these lenses, along a polygonal lens edge or within an overlap region, can be used to determine deviations from the idealized virtual pinhole. The previously noted polynomial or a spline curve fit model of the shape of the COP curve, at least along a polygonal edge, can be used to describe deviations of the idealized virtual pinhole relative to position or field angle. These angular differences equate to sampling differences of the light beam collected and image from an object, or a portion thereof, that is located at or near the edge of the imaged field. The angular differences in light reflected off an object feature and collected or sampled by the imaging lens, can depend on differences in the surface light reflectivity or absorption and the incident plenoptic light that illuminates it. During the process 400, each camera channel can be treated as having its own virtual pinhole location, that is typically different from the camera center location which could be defined as (0,0,0). In this example, the data from each channel may be processed to transform it from its virtual pinhole viewpoint to the camera center viewpoint. This adjusts for angular position such as theta, phi, in a spherical co-ordinate system.

At an operation 414, the process 400 may include determining an overlap region between two camera channels containing data related to the pixel location 114, as determined at the operation 412. In an example 416 shown, the two camera channels may comprise a first camera channel 418(1) and a second camera channel 418(2). The two camera channels 418(1), 418(2) may be associated with camera configuration data indicating idealized virtual pinhole locations 420(1), 420(2) and direction vectors 422(1), 422(2) corresponding to the respective camera channels 418(1), 418(2). The process 400 may determine an overlap region 424 between the camera channels 418(1) and 418(2) based on a known FOV (or an extended FOV) angle (e.g., as shown by angles θ_{A} and θ_{B}).

At an operation 426, the process 400 may include determining the pixel value at the pixel location 414. As shown in an example 428, a portion 430 of the projection image 408 may include the pixel location 414 at a location 432. The portion 430 includes projected portions of image data from multiple camera channels of the multi-camera system, illustrating regions of overlap between them, and illustrates geometrical considerations used in determining weighting factors associated with the camera channels. In the example 428, the location 432 may fall within an overlap region 434 of the camera channels 418(1), 418(2). Image 436 (1) captured by the camera channel 418(1) and image 436(2) captured by the camera channel 418(2) both include respective pixel values at the location 432, and may contribute data to the determination of the pixel value at the operation 426. For example, the image 436(1) may have a first pixel value at the location 432 and the image 436(2) may have a second pixel value, which may be different from the first pixel value, at the location 432.

When projected onto the surface of an imaginary sphere surrounding the multi-camera system, the overlap regions (e.g., the overlap region 434 shown) are roughly elliptical. However, modeling the perimeters of the overlap regions mathematically can be challenging. Instead, for any point within the overlap region, such as the location 432, the process 400 may calculate an angle characteristic at the point as the field of view (FOV) angle for each camera channel (e.g., 418(1) and 418(2)) at that point. For example, the process 400 may determine the dot product between a first directional vector, from the virtual pinhole location (420(1), 420(2)) of the respective camera channel to a point on the surface of the imaginary sphere corresponding to the location 432, and a second directional vector of the optical axis of the respective camera channel (e.g., vector 422(1), vector 422(2)). Since the dot product of two unit vectors is equivalent to the cosine of the angle between them, the arccosine of the dot product between the first directional vector and the second directional vector is the angle (in radians) corresponding to the angle characteristic at the location 432 for the respective camera channel. Within the FOV of each camera channel, such as the camera channels 418(1), 418(2), the angle characteristics of locations in the overlap region may range from about 29 degrees to 38 degrees, in some examples.

As an illustration, FIG. 4B shows plots 445 of angle characteristics for example locations within an overlap region, where the angle characteristic with respect to a first camera channel is plotted on a first axis and the angle characteristic with respect to a second camera channel is plotted on a second axis. As shown, the angle characteristic for locations in the overlap region computed for each camera channel is high at the extreme ends of the overlap region and is at a relatively low near the center. Because of this, the illustration appears to “fold over” the overlap region. This effect makes the asymmetry of the overlap regions evident. It is also to be noted that the two halves of the first and last example appear to be roughly aligned while the two examples in the middle are not. This is due to a very small displacement of the camera channels along their shared boundary. Further, some of the overlap regions are narrower than others due to differences in the overall angle between the view angle of the respective cameras, and some of the overlap regions are narrower at one end than the other due to a slight rotation of the camera channels with respect to each other., In addition, some of the overlap regions are narrower at one end than the other due to both pupil spherical aberration (PSA) and to slight rotations of the camera channels with respect to each other.

Further, for each camera channel pair 418(1), 418(2) that has an overlap region (e.g., the region 434), a plane can be defined using three points: the origin of the camera system, at a (non-zero) point along the optical axis of camera channel 418(1), and at a (non-zero) point along the optical axis of camera channel 418(2). When characterizing an overlap point (e.g., the location 432), it can be determined whether it is above or below this plane. This is done by calculating the dot product of the vector from the origin of the multi-camera system to its location on the imaginary sphere and the surface normal vector of the plane that bisects the overlap region. The sign of the dot product indicates whether the overlap point is above or below the plane. The magnitude of the dot product, which is the distance to the plane, is unused. By using the sign of the point with respect to the bisecting plane and the sign of the difference between the FOV angles to each camera, an overlap region (e.g., the region 434) can be categorized into four region quadrants. FIG. 4B illustrates four quadrants 446 of an overlap region. As shown, the edges 448 of the region quadrants are essentially linear when expressed in units of angle, which means that the shape of each region quadrant can be expressed with one, or two, line segments. Since the end portions of the overlap regions are quite small, the shape of the quadrant can be modeled with a single line. This means that each overlap region can be described with eight parameters, the slope and intercept for the boundary line of each region quadrant.

In some examples, at the operation 426, the process 400 may determine a distance (which may be an estimate) of the location 432 from an edge of the overlap region for each image 436(1) (e.g., edge 438(1)) and image 436(2) (e.g., edge 438(2)). The process 400 may determine weights for each image 436(1), 436(2) based on the distance (e.g., the weights may be inversely proportional to the distance). In some examples, additionally or alternatively, the distance may be computed as a distance or an estimated distance from a center of the image 436(1) and 436(2) (e.g., center 440 of 436(2) shown). In some examples, the pixel value at the location 414 may be determined as a weighted average of first pixel value of the image 436(1) and the second pixel value of the image 436(2) at the corresponding location 432. In other examples, the pixel value at the location 414 may be determined by stochastic sampling of the images 436(1), 436(2), where a probability of sampling from an image may be based on the weight corresponding to the image. Aspects of the operation 426 are described in further detail with reference to FIG. 4C.

In some examples, the process 400 may determine the pixel value at the operation 426 by based on content of the image data in the overlap region. As an example, a frequency signature may be determined for an area of the images including the overlap region indicating whether the overlap region includes high-frequency content (e.g., edges, texture, etc.) or low-frequency content (is relatively flat or uniform intensity and/or color). Different methods of combining the images 436(1) and 436(2) may be applied based on the frequency signature. For example, if high-frequency content is indicated, the process 400 may apply the stochastic sampling method described above to determine the pixel value, to represent such content more accurately in the panoramic image. Whereas, if low-frequency content is indicated, the process 400 may apply the weighted average method described above to determine the pixel value. As another example, the content of the image data may include a flare or a veiling glare, and the process 400 may determine the pixel value to compensate for the presence of the flare or the veiling glare, as discussed below.

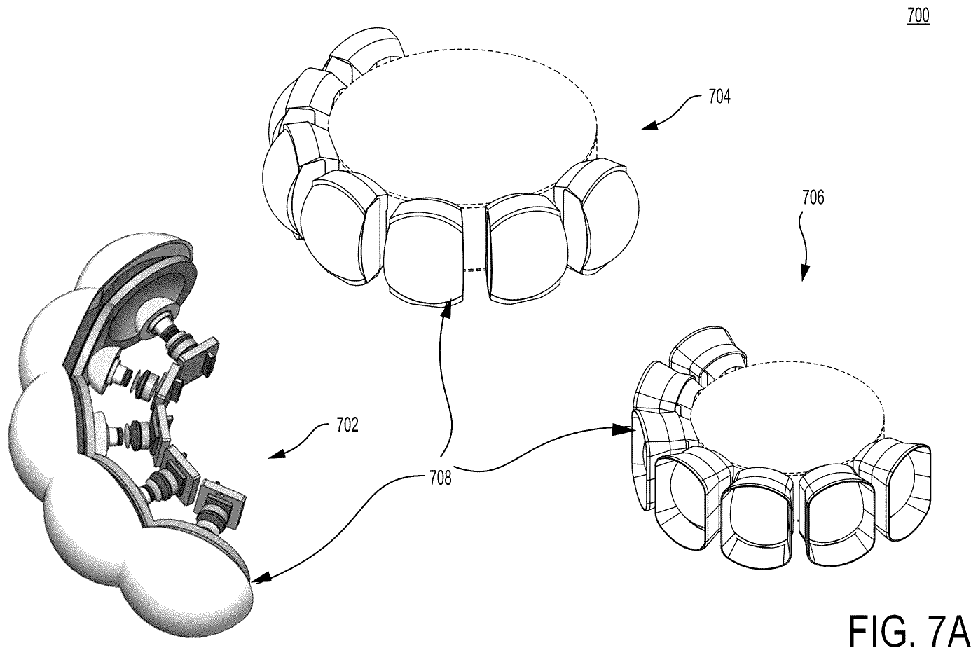

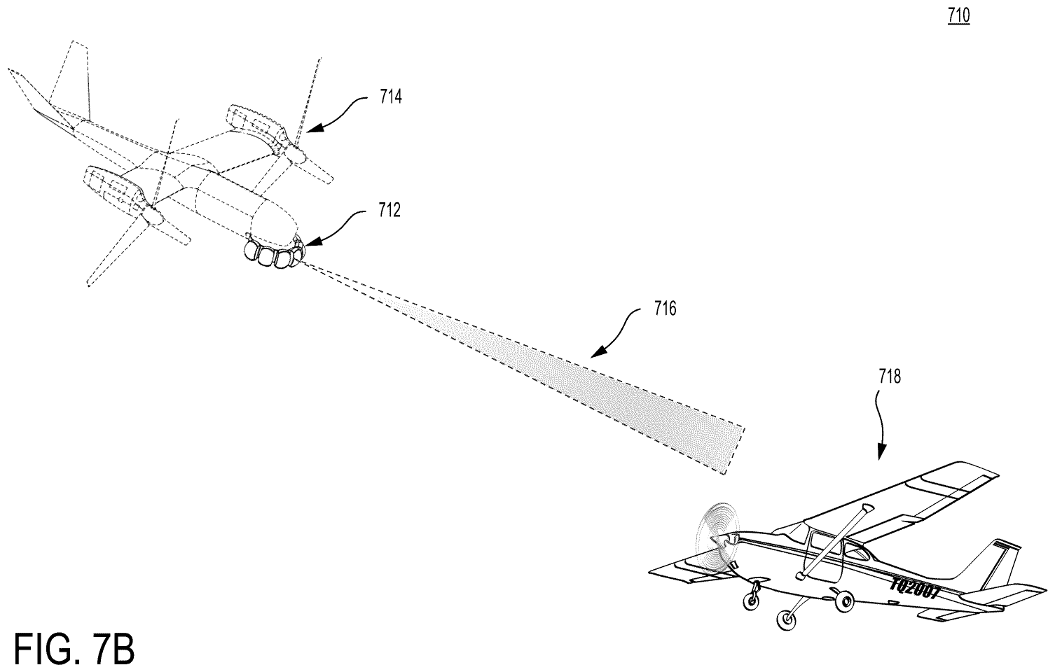

In some examples, the process 400 may determine the pixel value at the operation 426 based on whether an object or feature of interest is present in the overlap region. For example, as described with reference to FIG. 7B, the object of interest may be an aircraft in the scene captured by the multi-camera device. As an example, the process 400 may only determine the pixel value at the pixel location, as described above, if the pixel location is within an area (e.g., an ROI) covering the object of interest. Whereas, if the pixel location is not within the area covering the object of interest, the process 400 may simply determine the pixel value as the first pixel value or the second pixel value.

In some examples, in an optional operation 442, the process 400 may adjust an intensity level or color of the pixel value to apply corrections for color and exposure differences between camera channels. For example, at the operation 442, the process 400 may compensate for residual front color (as described with reference to FIG. 2C) between the camera channel(s), where fields of view of adjacent channels are vignetted by an edge of the lens. This correction can be done, for example, by applying lateral color image correction techniques to add red, green, and or blue channel information where it is missing. In particular, the existing image data from pixels that are impacted by front color can be analyzed to extract existing color information. Missing color components can be analyzed by accounting for the known structure (color, spacing, and width) of the residual front color, and by analyzing color data from nearby pixels and observation of the content to make decision on how much color gain to apply. Restoration or the front color modified pixel data can effectively expand the overlap regions in which image blending can be applied.

Front color is a type of chromatic aberration that occurs when the virtual projection of different colors of light appear to focus at different locations perpendicular to the lens. In a lens that is cut along its edges, this leads to clipping of some rays of light. Because those rays are clipped, some color never makes its way through the aperture stop to the image plane, leading to a loss of information about those clipped rays. This results in different colors being misaligned in the final image, typically along the outer edge where the lens clipping occurred, creating a distortion in color and a lack of sharpness in the image in those peripheral regions. Lateral color of the entrance pupil can be corrected through careful selection of lens materials in the lenses before the aperture stop. However, correction of front color can come at the expense of more expensive fabrication and manufacturing processes, more weight, and other tradeoffs in performance elsewhere in the imaging system. Therefore, it can be advantageous to limit the impact of front color through software. Color gradient, edge detection, or histogram matching algorithms can be used to correct or limit front color image artifacts.

Additionally, Artificial Intelligence (AI) or machine-learned (ML) models can be used to correct for lateral color aberration like that seen with front color by using machine learning algorithms to analyze and correct the colors in the image. There are several techniques in AI that can be leveraged for correcting front color. For example, a ML model may be trained using a dataset of images with known lateral color aberrations along with correct color values for those images. These images could be synthesized in mass scale using simulation software such as lens design programs Zemax and CodeV, and by running an image simulation on thousands of images. The model can then be used to analyze new images captured in the real-world by the camera channels, and correct the colors based on the patterns learned from the training dataset.

As another example, “inpainting”, which is an algorithm that fills in or “paints in” missing or aberrated pixels with appropriate color values, may be used for color corrections. For example, a pre-trained model may be used to analyze the image and identify areas of lateral color aberration. By way of example, if the pre-trained model is trained to correct red and blue color aberration, it will analyze the image and identify areas where red and blue colors are not aligned with the rest of the image. These areas may then be analyzed by an AI model to determine appropriate color values to replace the aberrated pixels with. Once the appropriate color values have been determined (using for example, training data as discussed above), the Al model may use inpainting techniques to fill in the aberrated pixels with the correct colors. This can be done by using interpolation, which estimates the color of the missing pixels based on the colors of the surrounding pixels. Inpainting can be performed in a selective way or through a global approach where the entire image is analyzed and corrected. Selective inpainting is usually more accurate, but can be computationally intensive, while global inpainting can be less accurate but faster.

The AI models above can use multiple techniques to determine appropriate color values that indicate an error including receiving a training set of images with aberrated pixels as discussed above. In addition, the AI models can make use of histograms, color gradient, or edge detection. These techniques can help the model to identify he aberrated pixels more accurately and correct the colors accordingly. The AI model may then apply a correction algorithm to adjust the colors in those areas to align them with the rest of the image. The model could fill in the aberrated pixel values with other RGB color information by analyzing patterns and relationships between the aberrated pixels and correct color values in the training data.

In some examples, multiple models can be blended together where blending in the context of AI refers to the process of combining the outputs or predictions of multiple models or algorithms to improve the overall accuracy or performance of the final result. Additionally, AI can also be used to analyze the lens used to capture the images and automatically apply the appropriate correction algorithm based on the lens's characteristics and the type of front color present in the image. These techniques require a substantial amount of high-quality data and computational power to train and use these models, but once trained and fine-tuned, these AI models can be very effective in correcting lateral color aberrations in images. In some examples, deconvolution techniques may be used to compensate for image quality degradation, if needed. Deconvolution is a mathematical technique used to restore or improve the image quality for images that have been degraded by a blur or convolution process.

Additionally, in practice, when using a low-parallax multi-camera system, such as the device 100, some camera channels may be pointed towards bright light sources while others may point towards dimly-lit corners with little or no illumination. At the operation 442, the process 400 may balance exposure of camera channels providing data for the panoramic image so that the panoramic image 406 appears consistently illuminated. For example, camera channels pointing towards bright light sources may reduce exposure and camera channels with low illumination may enhance exposure. During calibration of the multi-camera system, pixel responses in the overlap regions between camera channels may be measured to determine differences in pixel intensity values (e.g., 0-255 for 8-bits). This data can be used to compensate the exposure for the two camera channels 418(1), 418(2) iteratively, until pixel values across the overlap region are nearly the same. For each camera channel, a series of operations may correct pixel values according to a sequence of image chain operations. For example, raw image data can be corrected for dark noise, corrected for color by multiplying by a 3×3 matrix, de-Bayered into RGB values, etc.

Further, as described with reference to FIG. 1, the multi-camera system may experience different types of flare, glare, and ghost light. In general, veiling glare is caused by scattering in lens elements, reflections off the lens barrel, reflections off lens surfaces, and reflections from the sensor surface itself. The 2D function describing the intensities is known as the glare spread function (GSF) of the lens. In general, glare in a lens image can be reduced by post-processing using a deconvolution method. However, in some examples, glare may not be caused by visible scene features, and instead be caused by light entering the device from outside of its field of view. For example, two adjacent camera channels can experience a different uniform or non-uniform background flare that is caused by the different camera lenses being pointed at different light sources. As these flare-based image differences can extend to the image edges, it can cause uneven color and luminance responses along the blended image edges in the overlap region of two adjacent camera channels.

Veiling glare can be compensated for optically using premium anti-reflective (AR) coatings, reducing the size of the aperture, using fins on the periphery of outer lens elements to limit the amount of stray light that could enter the camera from outside its field of view, and through careful design of the lens to control for stray light. It can also be compensated for in software by identifying areas of the image that are affected by veiling glare, and applying a correction to improve the contrast and reduce the overall impact of glare. In addition, HDR imaging can be applied to generate imagery with a high dynamic range to capture both the bright and dark areas of a scene without overexposing the highlights or underexposing the shadows.

In some examples, glare can be caused by total internal reflection (TIR) inside a lens of a bright light source to form a ghost image. For example, as shown in FIG. 1, ghost light scenario may be caused by the light rays 167 coming from the right at an oblique angle to a camera channel. This light can enter the camera channel, encounter multiple TIR bounces, and end up on a light path where the light is incident on the image sensor, as a ghost image. For some systems and applications, protruding fins mounted in the seams between adjacent lenses can block light from entering such stray light paths. This ghost light will typically retain some structure, and typically have a noticeable color difference from surrounding pixels that received normal image data. Because of the unique characteristics of color and imaging, a ML model may be trained for detecting and removing glare artifacts, and in-painting those pixels with pixels based on the surrounding neighborhood of pixels, as discussed above.

In some scenarios, incident light at the first camera can provide a correlating clue to the occurrence of ghost image light in a second adjacent camera. Thus, content from different camera channels may be compared to identify ghost images or blur due to subject motion.

When gross disparities exist between the camera channels, then new strategies may be developed to perform the best possible blending operation. In some examples, light entering a first camera channel can form a regular image, while other portions of incident light from the same nominal direction may miss or reflect off the first camera channel, while other portions may create ghost image light in the adjacent second camera channel. As an example, this scenario can occur with incident sunlight. Solar light exposure to an image sensor can cause extended over-saturation, obscuring image capture of a bogey aircraft or other object. An algorithm can be used to manage global exposure across all camera channels in the multi-camera system, and the operation of the global exposure algorithm with a tone scale algorithm can be co-optimized. It is noted that a multi-camera system can also include an optoelectronic shutter to dim direct or indirect solar exposure to a camera channel's image sensor e.g., the shutter may be located in the optical path shortly before the image sensor, and may provide spatially variant dimming control.

In such a scenario, image data captured by the first camera channel can be analyzed, relative to color, luminance, size, motion, and other parameters, to help identify and compensate for the ghost image light seen in the second camera channel. In some examples, the process 400 may perform operation 442 to detect and correct for ghost images, modify exposures of the camera channels and/or apply color corrections prior to the operation 426. Additionally, in some examples, the weights used determined at the operation 426 may be adjusted based on factors such as motion, luminance, or color similarity and to reduce the impact of flare e.g., a weight may be reduced to ensure that bright pixels are not overly dominant in the panoramic image.

In some examples, the process 400 may improve the accuracy of correction of ghost images by using information from other camera channels capturing the same ambient light information. For example, a multi-view deconvolution algorithm may be used, where the GSF of each camera lens is corrected individually and then combined to create a final composite image (e.g., the panoramic image 406). This approach can help improve the accuracy of the of the correction by using multiple features of the same scene within overlap regions between adjacent camera channels to better estimate the scene. As another example, the process 400 may use camera calibration data (both intrinsic and extrinsic) to determine the positions and orientations of the camera channels in the multi-camera system. This information can further be used to estimate the location of light source(s) in the scene, and determine paths of light rays from the light source(s) through different lenses in the multi-camera system. Pixel values of the light source from different camera channels may then be used to attempt to correct for flare artifacts caused by the light source(s).

For example, compressive sensing techniques may be applied to the data from different camera channels to model the light source(s). Compressive sensing is a mathematical technique that can be used to acquire and reconstruct high-dimensional data from a limited number of measurements. It can be leveraged to determine the bidirectional reflectance distribution function (BRDF) of a light source by leveraging the images of the light source seen from the different viewpoints in the multiple images from different camera channels. The BRDF describes the way that light reflects off a surface as a function of the incoming and outgoing light directions. These images are then processed using a measurement matrix that is designed to have certain properties that make it better suited to the specific light source determined, where a ML model and object detection can help determine the light source. The measurement matrix is applied to the images of the light source in the different camera channels to project the images of the light source onto a lower-dimensional space. Next the images are processed using mathematical algorithms to reconstruct the original light source. The BRDF of the light source can then be determined by analyzing the properties of the light, such as its intensity and color, as well as the angles at which the light is reflected and scattered.

Additionally, machine learning algorithms such as neural networks can be employed to learn the properties of the light source and how it interacts with multiple cameras in the system. This can help to improve the accuracy of the reconstruction and the determination of the BRDF function. These compressive sensing techniques can be used to reconstruct a light source with fewer images than traditional methods, allowing for a more efficient and accurate determination of the BRDF function. It should be noted that if the camera captures multiple frames from different positions, those images of the light source can be used to improve the accuracy of these results.

Once the BRDF function of the light source is determined, it can be used to remove flare and glare due to that light source in each of the camera images by using the BRDF to estimate the amount of reflected light present in each cameras image and then subtract that estimate from the original image. As an example algorithm, an incoming light direction may be estimated in the image by using a combination of camera calibration data (intrinsic and extrinsic), and techniques to estimate the light sources position given the location of the highlights in the image. Based on the estimated angle of the incoming light and the BRDF of the light source, an amount of reflected light that is present in the image may be estimated by convolving the image with the BRDF, where the BRDF is treated as a filter, and the image is treated as the input signal. Finally, the estimated reflected light may be subtracted from the original image, removing the glare due to that light source. Other methods for glare removal may include using machine learning, deep learning, and optimization techniques.

At an operation 444, the process 400 may output the panoramic image 406, determining the pixel values at each pixel location of the panoramic image 406, as described above with respect to the example pixel location 414.

In some example, the process 400 can be adapted for use in scenarios in which imaging algorithms for creating equirectangular projections are imbedded in a field programmable gate array (FPGA) or other comparable processor, by implementing ongoing or on-demand pixel projection recalculation. The pixel values can be rapidly recalculated with little memory burden in real time. As another alternative example, the process 400 may evaluate the overlap regions and using a “grassfire” based algorithm to control the blending between the images 436(1), 436(2) in the overlap regions. The grassfire algorithm is used to express the length of the shortest path from a pixel to the boundary of the region containing it, and may be used in conjunction with precomputed grassfire mapping LUT. However, the LUT may require significant memory when creating the panoramic image from the image data.

FIG. 4C illustrates an example process 450 for determining weights corresponding to each camera channel to be used in combining data from respective camera channels in an overlap region, as described with reference to the operation 426 of the process 400.

At an operation 452, the process 450 includes determining, for a location (e.g., corresponding to a pixel location in a panoramic image), angle characteristics for each camera channel contributing data to the location. For example, the process 450 may determine a first angle characteristic with respect to a first camera channel and a second angle characteristic with respect to a second camera channel, as described with reference to FIG. 4A.

At an operation 454, the process 450 includes determining a distance of the location to a bisecting plane, and average and difference between the first angle characteristic and the second angle characteristic. As described with reference to FIG. 4A, the bisecting plane may be defined based on three points comprising: the origin of the camera system, a (non-zero) point along the optical axis of the first camera channel, and a (non-zero) point along the optical axis of the second camera channel. The process 450 may determine the distance of the location to the bisecting plane, and whether the location is above or below the plane (e.g., a sign of the distance may be negative or positive based on whether the location is below or above).

At an operation 456, the process 450 includes determining, based on the sign of the distance and the sign of the difference between the first angle characteristic and the second angle characteristic, a set of quadrant parameters. For example, the region quadrant corresponding to the location may be determined based on the sign of the distance and the sign of the difference, as described with reference to FIG. 4A, and the set of quadrant parameters may be determined based on the region quadrant corresponding to the location.

At an operation 458, the process 450 includes determining estimated distances to the edge of the overlap region of the first camera channel and to the edge of the overlap region of the second camera channel, based on the quadrant parameters determined at the operation 456.

At an operation 460, the process 450 includes determining weights corresponding to the first camera channel and the second camera channel based on respective estimated distance to the edge of the overlap region for each camera channel, as determined at the operation 458.

As noted previously, the simplifying assumption that a camera lens system can be represented by an ideal virtual pinhole is typically used in modeling the camera. However, the multi-camera device (such as the device 100) and corresponding lens systems (such as the lens system 200) described herein are designed with explicit control over parallax or perspective. This knowledge may be used for imaging applications such as photogrammetry, or aircraft collision avoidance, where imaging accuracy is important, and the known variation in residual parallax or perspective error (as shown in FIG. 2D) along a polygonal lens edge represents the known deviation away from the idealized pinhole assumption.

### 3D Modeling

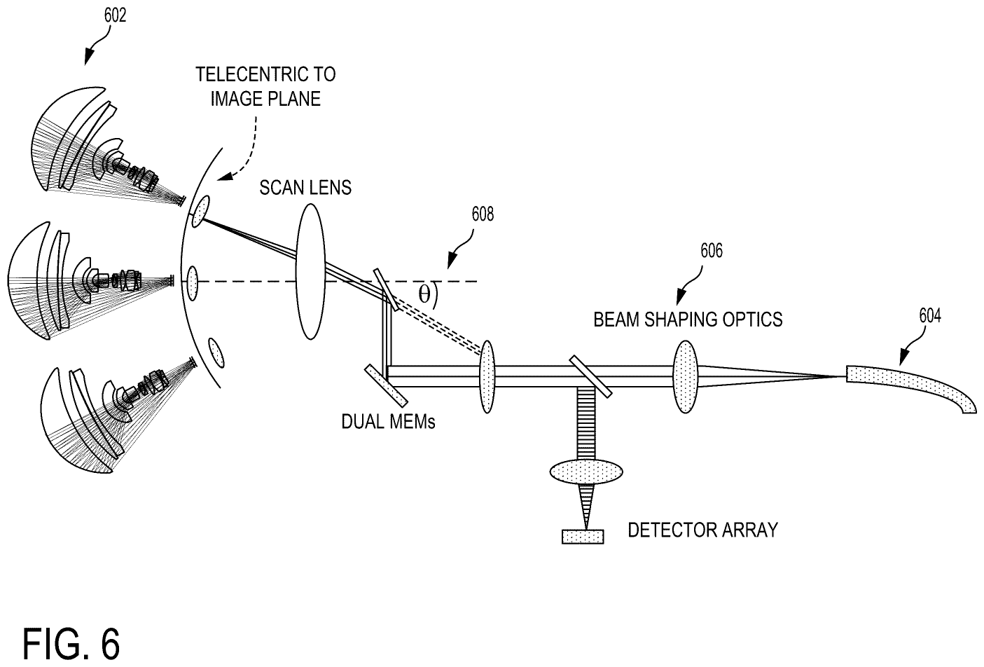

FIG. 5 illustrates use of the multi-camera device described herein in a photogrammetry application. Photogrammetry is a technique for extracting geometric information from 2D images. By analyzing the position and orientation of features in multiple images, photogrammetry techniques can be used to generate accurate 3D models of objects and scenes. As compared to conventional cameras used in photogrammetry, a multi-camera low-parallax device (e.g., the device 100 of FIG. 1) can be used to capture panoramic image data to enable simultaneous photogrammetric models or digital twins of a scene or environment (e.g., an archaeological dig site) or objects therein. This camera system can have a spherical (e.g., the dodecahedral geometry 410), hemispherical, or conical multi-camera geometry.

A multi-camera device 100, as described herein, has the advantage of capturing more of the scene in each image capture than a traditional camera system, which can result in more accurate and detailed 3D models with less processing. Accurate alignment and blending of the panoramic images is crucial for improving the quality of the point cloud and mesh, leading to more accurate and visually appealing 3D models.

As illustrated in FIG. 5, a workflow for generating 3D models with a multi-camera device 502 (which may be the device 100) may include: (i) capturing a set of images (i, . . . , i+N) 504 of the scene to be modeled from different viewpoints; (ii) using camera calibration information to determine intrinsic and extrinsic parameters for each image of the images 504; (iii) aligning the images 504 using feature matching techniques such as by matching corresponding feature point 506 (e.g., using techniques such as SIFT, SURF, ORB, and other similar methods; (iv) generating a 3D point-cloud 508 from the aligned images; and (v) using the point cloud to generate a mesh of the subject or scene, which can then be textured with pixel values from the corresponding images to create a realistic 3D model.

In examples of the present disclosure, the workflow may include compensating for the shifts in perspective or pinhole center of the device 502 as a function of field angle using calibrated intrinsic and extrinsic camera data (e.g., using data shown in FIG. 2D).In some examples, enhancements to step (iii) can be made by employing a high-resolution inertial measurement unit (IMU) mounted to the device 502 to estimate motion between camera frames (e.g., between capture of image (i) and image (i+1)). In some examples, at step (iii), a set of corresponding feature points matched can be used with optimization algorithms, such as RANSAC, to estimate the alignment of the images 504.

### Combination With Lidar Data

In some examples, for applications including photogrammetry and collision avoidance, where accurate range data is needed to an object or feature, the optical designs of the low-parallax multi-camera devices (such as the device 100) can be optimized to enable co-axial imaging and LIDAR. As one example, the optical designs can include both a low-parallax objective lens (such as the lens system 200), paired with an imaging relay lens system, the latter having an extended optical path in which a beam splitter can be included to have an image sensor in one path, and a LIDAR scanning system in another path. Alternately, the beam splitter can be embedded in the low-parallax objective lens design, with the imaging sensor and the LIDAR scanning system both working directly with the objective lens optics and light paths. As another alternative system 600 depicted in FIG. 6, a single LIDAR scanning system can be shared across multiple low-parallax objective lenses 602 (which may each be similar to the lens system 200). In the system 600, light from a laser source 604 is directed through beam shaping optics 606 and off of MEMs scan mirrors 608, to scan through a camera system comprising the lenses 602, where beam splitters would direct image light out of the plane of the page. Although the LIDAR beam resolution may not match a camera's imaging resolution, that can be partially compensated for by controlling the LIDAR scan addressing resolution.

For example, for the previously discussed photogrammetry application (FIG. 5), LIDAR will have less resolution than the low-parallax imaging devices 502, and thus, a LIDAR system will subsample an imaged object and the 3D model. However, the LIDAR data can add accuracy to the range or depth measurements to an imaged object or features therein. Using the subsampled range data, and a difference (A) between the estimated 3D point using photogrammetry and its actual value determined with LIDAR, interpolation can be used to accurately determine a correct 3D location for scanned 3D points and intermediate points in between. The LIDAR data adds depth information to spherical image data, such that multiple RGB-D spherical images (where D refers to depth or range data) can be fused together to create a 3D or 4D vector space representation. In close environments, the laser sources used in LIDAR systems may be replaced by LEDs, providing visible or IR light to scan or flash illuminate a local environment.

Merging LIDAR data with image data (which may cover nearly 360-degrees) of a low-parallax, multi-camera device described herein (such as the device 100) can be used for various applications, such as autonomous driving, virtual reality, and mapping. In some examples, an example method of merging LIDAR data with the image data may include capturing both the LIDAR data and the image data simultaneously, dividing the image data into smaller segments, and projecting the LIDAR data onto the image plane of each segment to obtain a colored LIDAR point cloud for the segment, that is colored using pixel values from the corresponding image data of the segment. This example method provides several advantages over existing methods using cameras with overlapped fields of view, including improved accuracy, reduced computational complexity, and better handling of occlusions. The resulting combined data stream can be used for a variety of applications including autonomous robotics, virtual reality, and mapping applications.

In further detail, the example method for merging LIDAR data with the image data may include:
(i) capturing LIDAR data simultaneous with the image data from a low-parallax multi-camera device, where the LIDAR capture unit is offset by a pre-set distance;
(ii) preprocessing the LIDAR data to remove any noise or outliers and converting the LIDAR data into a point cloud;
(iii) dividing the 360-degree image data into smaller segments (e.g., using an equirectangular projection), covering, as an example, 30-degree segments;
(iv) for each segment, finding the corresponding LIDAR points that fall within its field of view;
(v) for each LIDAR point that falls within a segment's field of view, projecting its position onto the image plane using the camera's intrinsic and extrinsic calibration data;
(vi) for each projected LIDAR point, finding the corresponding pixel in the segment's image data using nearest-neighbor interpolation;
(vii) assigning the value of the LIDAR data to the corresponding pixel; and
(viii) repeating the above steps for each segment of the image data.

In examples, at step (v), LIDAR points that fall within a segment's field of view may be determined by calculating a ray between the position of the multi-camera device and each LIDAR point, using intrinsic and extrinsic camera parameters to transform each LIDAR point into the device's coordinate system. When merging LIDAR data and panoramic camera data, it should be noted that the LIDAR data will likely have less resolution than the image data. In such examples, interpolation may be used to fill in the missing data using various techniques, such as nearest neighbor, linear, or cubic interpolation. An output of the method includes an overlay of the LIDAR data atop the image data of the scene.

### Object Detection and Tracking

As another application example, the type of low-parallax multi-camera image capture device (such as the device 100) described herein can also be optimized for, and used to enable enhanced safety for air or ground vehicles. As an example, FIG. 7A illustrates image capture devices 702, 704 and 706 with a series of low-parallax cameras 708 (e.g., similar to the camera channels 120A, 120B) mounted annularly together to form a visor or halo, that can be used to monitor a scene. It is to be noted that the cameras shown may have rectangular or square FOVs. Without limitation, the arrangement of FIG. 7A can be coupled to a drone, aircraft, or other flying object, generally as shown in FIG. 7B. This type of system can also be “ground” mounted, for example on a pole or a building, and then used to monitor unmanned aerial vehicle (UAV) or electric vertical take-off and landing (eVTOL) vehicle air traffic. In such a system, lenses, or camera channels with either square or rectangular FOVs can be tiled together forming a composite field of view, and there is no pre-defined geodesic structure. As with the lens housings 130 of FIG. 1, the lens housings of these adjacent camera channels are opto-mechanically mounted in proximity, to maintain nominal parallelism across the intervening seams so as to retain the optical benefits of low-parallax control between cameras. As before, these cameras can be designed with some extended FOV (e.g., ≤1°) to both help the opto-mechanical design and enable image blending and other software functions between adjacent lenses. As a particular example shown in FIG. 7B, an arced array of 6 cameras in a visor configuration 712, can be mounted onto a UAV 714 (or drone) or eVTOL and be used in-flight to simultaneously monitor a +100° horizontal FOV and a +20° FOV for potential collision risks. This system, for example, can image visible light, infrared (IR) light, or a combination thereof. The resulting image data can be analyzed for collision avoidance, to enable detect and avoid (DAA) functionality. The image data from the image sensors can be output to an image processor, containing a GPU, FPGA, or SOC, on which algorithms are used to examine an airspace, as sampled by the imaged FOVs from each of the cameras, to look for one or more bogey aircraft. If a bogey aircraft 718, such as a Cessna 172 shown, is detected, the DAA software can be used to track it within the imaged FOV. This data can then be output to another processor which assesses the current collision risk and determines appropriate collision avoidance maneuvers. That data can then be delivered to an autopilot, a pilot, or a remote operator.

In some examples, the DAA bogey detection system can simultaneously monitor each camera's FOV in entirety, or subsets thereof, using iterative windowing. As real-time detection of bogey or non-cooperative aircraft flying in an airspace can be a difficult task, and can impose a significant computational burden, windowing, to scan over a camera's full FOV to look for something new at reduced frame rate (e.g., 1-5 fps) can be valuable. Once a potential bogey is detected, it can be adaptively tracked using a light weight non-sophisticated program to look for changes in lighting, attitude, or orientation over time. Such a system may also track multiple objects at once within the FOV of a single camera, or within the FOV of multiple cameras (FIG. 11A). The DAA bogey detection system may include DAA software implementing algorithms to recognize or classify objects, with priority being directed at the fastest or closest bogeys over others. Bogey range estimation can then be enabled by bogey recognition, stereo camera detection, LIDAR scanning, or radar. Once detected, a bogey can be detected using a tracking window or region of interest (ROI) or instantaneous FOV (IFOV) that can be modestly bigger than the captured image of the bogey, but which is much smaller than a camera channel's full FOV.

For example, the DAA software may use the Haar Cascade classifier to detect specific objects (or bogeys) based on their features, such as size, shape, and color. Once a potential bogey is detected, a lightweight tracking algorithm such as the Kanade-Lucas-Tomasi (KLT) tracker can be used to track the bogey's movement over time. Multiple objects can be tracked simultaneously using a multi-object tracker such as the Multiple Object Tracker (MOT) algorithm.

To estimate bogey range, various sensors such as stereo cameras, LIDAR, or radar can be used. For sterco camera detection, algorithms such as the Semi-Global Matching (SGM) algorithm can be used to compute depth maps and estimate range. For LIDAR or radar, signal processing algorithms can be used to estimate range based on time-of-flight or Doppler shift. When using a monoscopic camera alone, depth estimation can be a challenging problem. Some methods to determine depth from monoscopic imagery include object identification to determine the object, and looking up its size from a lookup table. Knowledge of the objects size and pixels subtended can be used to estimate its range. Another method is to use depth from focus, where the image sensor position is adjusted to find the position of best focus. This knowledge can be used to determine the approximate distance to the object. Machine learning and neural networks can also be employed to estimate range from a large training set of data.

In examples where a low parallax multi-camera system (e.g., the systems 702, 2004, 706 of FIG. 7A), mounted on a first aircraft (an ownship), is used to capture images to help enable aircraft collision avoidance via DAA software analysis, a scenario may occur where a bogey can travel through an overlap region between two adjacent cameras, or within an overlap region, as it flies either towards or away from the first aircraft. For this type of application, whether a visor system is deployed on an air or ground vehicle, the plurality of cameras can enable panoramic situational awareness of events or objects within an observed environment. For some applications, it can be advantageous to apply a blending method (e.g., the process 400 of FIG. 4A) to the plurality of overlap regions, to produce a seamless panoramic image for object or DAA detection analysis. In other applications, such as airborne DAA, where constraints may strongly limit the system capabilities, it may be preferable to analyze imagery from each camera separately and prioritize computational power at any given time to image content from one or more portions of a camera's FOV where a bogey has been detected. In such cases, an image blending method (e.g., the process 400 of FIG. 4A) can be applied selectively only when a bogey aircraft is traversing an overlap region, and for a short time both prior to and after such a traversal. During such circumstances, the blending method can preferentially be applied locally, within an oversized digital window that includes the bogey image, to follow the bogey through the overlap region from a first camera to a second camera. Alternately, the blending method can be applied to a larger portion, or the entirety of the overlap region between the two cameras, without necessarily applying it to the overlap regions between other camera pairings. As with the photogrammetry application, the image blending method can also be optimized for the application, using, for example a frequency decomposition to identify and favor the camera that locally provides better image quality, or using the parallax data (e.g., graph 232 shown in FIG. 2D) to locally correct away from an ideal virtual pinhole assumption. As an example, when an object is tracked across an adjacent camera's boundary by using a Kalman filter to predict the object's location, the intrinsic and extrinsic calibration data for both cameras can be used to form a perspective projection of the pixels as defined by the Kalman filter. During such operations, the DAA system, including the visor camera system, can use data from an inertial measurement unit (IMU) to help correct for changes in the aircraft's own motion or vibrations.

For this type of DAA applications, or ones for UAV or eVTOL traffic monitoring, or other applications, it can be advantageous to have a dual visor or halo system, where a second visor or halo system is out of plane parallel offset from a first one. This second visor or halo system can also image the same spectral band (e.g., visible, with or without RGB color), so that in cooperation with the first system, sterco imaging and range or depth detection is enabled. Alternately, the second visor can be equipped with another sensing modality, such as monochrome, LIDAR, IR, or event sensor cameras. The monochrome camera can be filled in with color data, using a trained neural network that uses up-resolution techniques to merge the color data with the higher resolution monochrome camera feed. When an event sensor is used, high framerates of 10k FPS+ can also be used to detect sounds in the video feed.

Image blending techniques, as described herein, can be applied in the overlap regions of one or both camera systems, either generally, or selectively, as needed. Also, the offset camera arrays can be aligned with their overlap regions aligned to one another, or with a radial offset. In the latter case, image data from one camera array can be used to inform image blending in a corresponding overlap region of the other camera array.

As discussed previously, the parallax data (e.g., as shown in FIG. 2D) can be applied using modeled or measured data, to modify the weighting factors over a lens field of view that are applied during image blending to enable a more accurate blending of image content of key features in a scene. As another example, the image data in overlap regions can be analyzed via frequency decomposition, to identify the best image data available from either of the adjacent cameras. The better-quality image data can then be favored for at least key image features during a local blending in an overlap region. Image blending can also be applied selectively, in overlap regions, or portions thereof, where high quality photogrammetric image data is needed, but skipped elsewhere where the content is lacks distinctive features.

### Alternative System Configuration

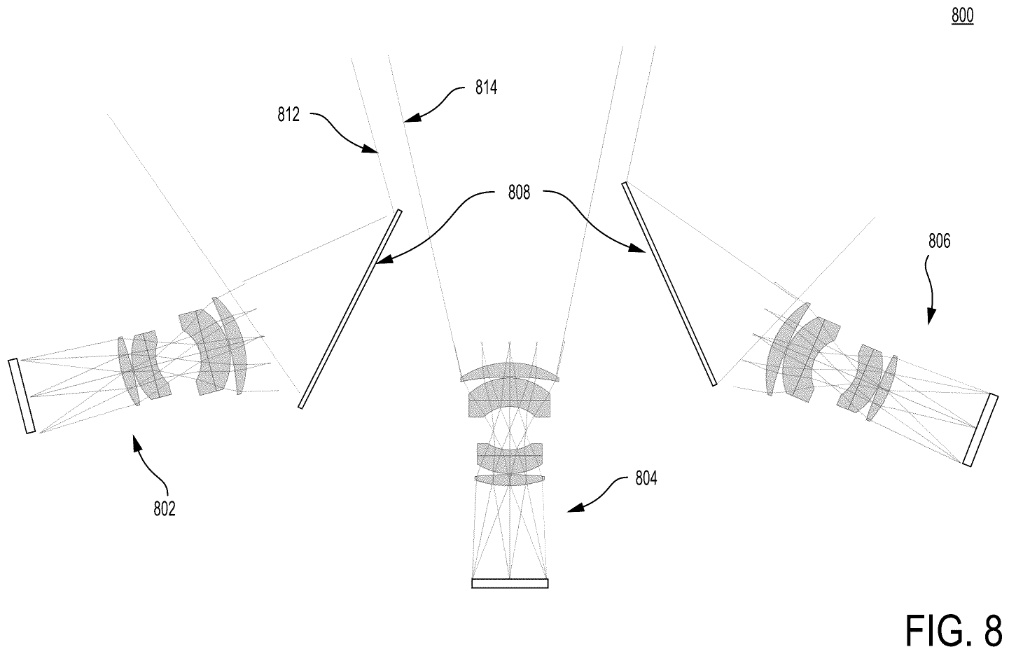

FIG. 8 depicts a portion of an alternate system configuration 800 to the device 100, or the devices 702, 704, 706 discussed with reference to FIG. 1 and FIG. 7A. In this example, three adjacent cameras 802, 804, 806 are provided, consisting of a central camera (camera 804) and a pair of adjacent cameras (camera 802 and camera 806), where light rays are folded by mirrors 808 into paths where, for example the inner edge 812 of the imaged FOV provided by camera 802 may be parallel to a respective outer edge 814 of the FOV imaged by the central camera 804. Supporting opto-mechanics (not shown) would support the camera channels 802, 804, 806 and the fold mirrors 808 to maintain the system configuration 800 and alignment. In this example, the FOV edge is defined by the image sensors, without the benefit of a low-parallax lens design (e.g., as shown in FIG. 2A). Thus, the chief rays along the edge of the FOV will have increased parallax or perspective error, versus what is possible (e.g., FIG. 2D). However, as the individual camera FOV is reduced by design and camera calibration, the residual parallax or perspective errors can also be reduced, though not as completely as a system (100) with cameras directly optimized for low-parallax performance. It is noted that a system of the type shown in FIG. 8, with optical folds, enabled by mirrors or prisms, will occupy more space than a tightly integrated system (e.g., the lens system 200 of FIG. 2A) with a plurality of low-parallax lenses. Additionally, the number of adjacent camera channels that can be tightly integrated with folds is fewer. However, as the FOV of the individual camera channels decreases, it becomes easier to integrate more camera channels together without the folds creating spatial conflicts. If the individual camera FOV's become small enough, and the nominal image distance large enough that the mechanical width of the intervening seams is large enough, then a plurality of angled cameras may be stacked adjacently to each other, along an arc, without the use of fold mirrors. However, for a system like the system 800 with optical folds, or a system with smaller FOV cameras and without optical folds, an extended FOV or overlap region (e.g., ≤3°) would be provided to aid both software calibration and corrections and opto-mechanical alignment. In either case, an image blending method (e.g., the process 400 of FIG. 4A) can be applied to improve the image quality in overlap regions.

As another alternative, a low-parallax camera system can follow an octahedral geometry, but be a half-octahedron, where each of the four camera channels includes a prism, to fold image light by 45 degrees into parallel optical paths, and their intervening seams, onto a single image sensor. Right angle prisms can be used with single folds, to map all four images onto a single plane and sensor. Alternately, half penta-prisms or Schmidt prisms can be used to rotate light 45 degrees. Intrinsic and extrinsic calibration data are determined for every camera channel and software is run to convert the imagery to a single output image buffer (half an equirectangular for example). The use of a single image sensor can reduce system cost and simplify some aspects of system calibration. Given the large FOV per camera channel, the optical system performance, including resolution will be reduced versus other designs. Also, the optical path length can vary within a camera channel, depending on where in the prism the image rays go through. This can cause image defocus that can be corrected using defocus algorithms to crispen image quality.

Although some applications of the low-parallax, multi-camera system described herein are discussed (e.g., related to 3D modeling of objects and scenes and object tracking for detection and avoidance of aerial objects), it is to be understood that such a camera system may be provide advantages in other applications. Additionally, though some configurations of the low-parallax, multi-camera system are described herein, other configurations are also envisioned.

What is claimed is:

1. A multi-camera system for generating a panoramic image, the multi-camera system comprising:
a plurality of camera channels, individual of the plurality of camera channels being configured to capture image data in a respective field of view;
memory;
a processor; and
computer-executable instructions stored in the memory and executable by the processor to perform operations comprising:
receiving information specifying a panoramic image to be generated;
for a pixel location in the panoramic image, determining, based on the information and camera configuration data associated with the plurality of camera channels, at least a first camera channel associated with a first field of view and a second camera channel associated with a second field of view, wherein the first field of view and the second field of view include the pixel location;
determining, based on the camera configuration data, an overlap region between a first image captured by the first camera channel and a second image captured by the second camera channel;
determining, based on a first portion of the first image in the overlap region and a second portion of the second image in the overlap region, a pixel value associated with the pixel location; and
generating the panoramic image including the pixel value at the pixel location.

2. The multi-camera system of claim 1, wherein determining the pixel value comprises:
determining a weighted average of a first value of a first pixel in the first portion of the first image and a second value of a second pixel in the second portion of the second image,
wherein the pixel value associated with the pixel location is based on the weighted average.

3. The multi-camera system of claim 2, wherein weights of the weighted average are based on a first distance between the first pixel and an edge of the overlap region and a second distance between the second pixel and the edge of the overlap region.

4. The multi-camera system of claim 2, wherein weights of the weighted average are based on a first distance between the first pixel and a center pixel of the first image and a second distance between the second pixel and a center pixel of the second image.

5. The multi-camera system of claim 1, wherein determining the pixel value comprises:
determining a first weight corresponding to the first image and a second weight corresponding to the second image; and
sampling pixel values from the first image and the second image based on the first weight and the second weight,
wherein the pixel value is based on the sampled pixel values.

6. The multi-camera system of claim 1, wherein determining the pixel value is based on content of the first image and the second image in the overlap region.

7. The multi-camera system of claim 6, the operations further comprising:
determining a frequency signature of the content;
based on the frequency signature, determining the pixel value using one of:
weighted average of pixel values of the first image and the second image, or
stochastic sampling of pixel values of the first image and the second image.

8. The multi-camera system of claim 6, wherein the content comprises one of: a flare or a veiling glare.

9. The multi-camera system of claim 1, wherein:
the plurality of camera channels comprise at least three camera channels,
the field of view comprises a polygon of more than four sides, and
the panoramic image comprises an equirectangular panorama.

10. The multi-camera system of claim 1, wherein the camera configuration data includes intrinsic calibration data and extrinsic calibration of the plurality of camera channels, the operations further comprising:
determining a first mathematical model corresponding to intrinsic calibration data of the first camera channel;
determining a second mathematical model corresponding to intrinsic calibration data of the second camera channel;
determining, based on extrinsic calibration data, a third mathematical model corresponding to the overlap region of the first image and the second image,
wherein the first portion of the first image in the overlap region and the second portion of the second image in the overlap region is determined using the third mathematical model.

11. The multi-camera system of claim 1, wherein determining the first camera channel comprises:
determining, based on the camera configuration data, a location on an imaging sphere corresponding to the multi-camera system associated with the pixel location in the panoramic image; and
determining that the first field of view includes the location on the imaging sphere.

12. The multi-camera system of claim 1, the operations further comprising:
determining respective exposure levels associated with the first camera channel and the second camera channel;
adjusting, based on the respective exposure levels, pixel values in the overlap region of the first image and the second image.

13. The multi-camera system of claim 1, wherein the panoramic image is a first panoramic image of a scene and the first image and the second image are captured from a first position of the multi-camera system, the operations further comprising:
receiving a set of images of the scene captured from a second position of the multi-camera system;
determining, based on the set of images, a second panoramic image; and
determining, based on the first panoramic image and the second panoramic image, a 3D model of a portion of the scene.

14. A method for generating a panoramic image, comprising:
receiving a plurality of images of a scene captured by a respective plurality of camera channels;
determining, based on camera configuration data associated with the plurality of camera channels, an overlap region between a first image of the plurality of images captured by a first camera channel and a second image of the plurality of images captured by a second camera channel,
wherein the overlap region includes a representation of content in a portion of the panoramic image;
determining, based on first pixel values of the first image in the overlap region and second pixel values of the second image in the overlap region, a pixel value associated with a pixel location in the portion of the panoramic image; and
generating the panoramic image including the pixel value at the pixel location.

15. The method of claim 14, wherein the plurality of camera channels comprise at least three low-parallax cameras, wherein at least one edge of a first camera adjoins an edge of a second camera.

16. The method of claim 14, further comprising:
determining, based on a first location of the first pixel values and a second location of the second pixel values, a first weight corresponding to the first image and a second weight corresponding to the second image,
wherein determining the pixel value comprises one of:
determining, based on the first weight and the second weight, a weighted average of a portion of the first pixel values and the second pixel values, or
determining, based on the first weight and the second weight, a stochastic sampling of the first pixel values and the second pixel values.

17. The method of claim 14, further comprising:
receiving, an object track associated with two or more camera channels of the plurality of camera channels,
wherein determining the first image and the second image is based on the object track.

18. The method of claim 14, wherein determining the pixel value is based on content of the first image and the second image in the overlap region.

19. The method of claim 14, further comprising:
receiving, first calibration data associated with the first camera channel and second calibration data associated with the second camera channel; and
adjusting, based on the first calibration data and the second calibration data, the first pixel values and the second pixel values.

20. The method of claim 14, wherein determining the pixel value is based on inputting, to a machine-learned model, the first pixel values and the second pixel values.
